(19) United States
(12) Patent Application Publication
(10) Pub. No.: US 2023/0276411 A1
(43) Pub. Date: Aug. 31, 2023

(54) METHOD AND DEVICE FOR TRANSMITTING OR RECEIVING DATA BY USING DUAL CONNECTIVITY OF IAB NODE IN WIRELESS COMMUNICATION SYSTEM

(71) Applicant: Samsung Electronics Co., Ltd., Suwon-si, Gyeonggi-do (KR)

(72) Inventors: Seunghoon CHOI, Suwon-si (KR); Youngbum KIM, Suwon-si (KR); Hyunseok RYU, Suwon-si (KR)

(21) Appl. No.: 18/007,954

(22) PCT Filed: Jun. 2, 2021
(86) PCT No.: PCT/KR2021/006866

§ 371 Date: Dec. 2, 2022

(30) Foreign Application Priority Data
Jun. 3, 2020 (KR) 10-2020-0067329

(51) Int. Cl. H04W 72/02; H04W 72/12; H04W 72/27

(52) U.S. Cl. CPC H04W 72/02; H04W 72/12; H04W 72/27

(57) ABSTRACT

The present disclosure provides a method, performed by an integrated access and backhaul (IAB) node, of transmitting and receiving data in a wireless communication system. The method may include: receiving resource allocation information from an IAB donor node, receiving first resource scheduling information from a first parent IAB node, receiving second resource scheduling information from a second parent IAB node, transmitting and receiving data to and from at least one of the first parent IAB node, the second parent IAB node, a child IAB node, or a user equipment (UE), based on the resource allocation information, the first resource scheduling information and the second resource scheduling information.

### TECHNICAL FIELD

The present disclosure relates to a wireless communication system, and more particularly, to a method and device for transmitting and receiving data by using dual connectivity of an integrated access and backhaul (IAB) node.

### BACKGROUND ART

In order to meet increasing demand with respect wireless data traffic after the commercialization of 4th generation (4G) communication systems, efforts have been made to develop 5th generation (5G) or pre-5G communication systems. For this reason, 5G or pre-5G communication systems are called ‘beyond 4G network’ communication systems or ‘post long term evolution (post-LTE)’ systems.

In order to achieve high data rates, implementation of 5G communication systems in an ultra-high frequency millimeter-wave (mmWave) band (e.g., a 60-gigahertz (GHz) band) is being considered. In order to reduce path loss of radio waves and increase a transmission distance of radio waves in the ultra-high frequency band for 5G communication systems, various technologies such as beamforming, massive multiple-input and multiple-output (massive MIMO), full-dimension MIMO (FD-MIMO), array antennas, analog beamforming, and large-scale antennas are being studied.

In order to improve system networks for 5G communication systems, various technologies such as evolved small cells, advanced small cells, cloud radio access networks (Cloud-RAN), ultra-dense networks, device-to-device communication (D2D), wireless backhaul, moving networks, cooperative communication, coordinated multi-points (CoMP), and received-interference cancellation have been developed.

In addition, for 5G communication systems, advanced coding modulation (ACM) technologies such as hybrid frequency-shift keying (FSK) and quadrature amplitude modulation (QAM) (FQAM) and sliding window superposition coding (SWSC), and advanced access technologies such as filter bank multi-carrier (FBMC), non-orthogonal multiple access (NOMA), and sparse code multiple access (SCMA) have been developed.

The Internet has evolved from a human-based connection network, where humans create and consume information, to the Internet of things (IoT), where distributed elements such as objects exchange information with each other to process the information. Internet of everything (IoE) technology has emerged, in which the IoT technology is combined with, for example, technology for processing big data through connection with a cloud server. In order to implement the IoT, various technological elements such as sensing technology, wired/wireless communication and network infrastructures, service interface technology, and security technology are required, such that, in recent years, technologies related to sensor networks for connecting objects, machine-to-machine (M2M) communication, and machine-type communication (MTC) have been studied. In the IoT environment, intelligent Internet technology (IT) services may be provided to collect and analyze data obtained from connected objects to create new value in human life. As existing information technology (IT) and various industries converge and combine with each other, the IoT may be applied to various fields such as smart homes, smart buildings, smart cities, smart cars or connected cars, smart grids, health care, smart home appliances, and advanced medical services.

Various attempts are being made to apply 5G communication systems to the IoT network. For example, technologies related to sensor networks, M2M communication, and MTC are being implemented by using 5G communication technology using beamforming, MIMO, and array antennas. Application of cloud radio access network (Cloud-RAN) as the above-described big data processing technology may be an example of convergence of 5G communication technology and IoT technology.

Recently, various studies are performed to use an integrated access and backhaul (IAB), and accordingly, there is a demand for enhancement in communication services in a dual connectivity environment of an IAB node.

### DISCLOSURE

### Technical Solution

The present disclosure provides a method and device for effectively providing a service in a mobile communication system.

In more detail, when an integrated access and backhaul (IAB) communication system is operated, in which an IAB node is configured for dual connectivity to a plurality of parent IAB nodes on a higher level of the IAB node, data transmission and reception between distributed units (DUs) of the parent IAB nodes and a mobile termination (MT) of the IAB node and data transmission and reception between a DU of the IAB node and an MT of a child IAB on a lower level of the IAB node or an access UE are mixed, such that it may be difficult to satisfy a half-duplex constraint in an instant, the present disclosure provides various methods for communication while the half-duplex constraint is satisfied.

### Advantageous Effects

According to embodiments of the present disclosure, provided are a device and method for effectively providing a service in a wireless communication system.

### DESCRIPTION OF DRAWINGS

FIG. 1 illustrates a communication system where an integrated access and backhaul (IAB) node is operated according to an embodiment of the present disclosure.

FIG. 2 is a diagram schematically illustrating each multiplexing of an access link and a backhaul link in a time domain or frequency domain at an IAB node according to an embodiment of the present disclosure.

FIG. 3 is a diagram illustrating multiplexing of an access link and a backhaul link in a time domain in an IAB communication system according to an embodiment of the present disclosure.

FIG. 4 is a diagram illustrating multiplexing of an access link and a backhaul link in frequency and spatial domains in an IAB communication system according to an embodiment of the present disclosure.

FIG. 5 is a diagram schematically illustrating an architecture of an IAB node according to an embodiment of the present disclosure.

FIG. 6 is a diagram illustrating a communication system according to an embodiment of the present disclosure.

FIG. 7 is a diagram schematically illustrating a dual connectivity structure of an IAB node according to an embodiment of the present disclosure.

FIG. 8 is a diagram schematically illustrating a dual connectivity structure of an IAB node according to an embodiment of the present disclosure.

FIG. 9 is a diagram schematically illustrating an environment that may occur according to real-time coordination in a dual connectivity structure of an IAB node according to an embodiment of the present disclosure.

FIG. 10 is a flowchart for describing a method, performed by an IAB node, of transmitting and receiving data according to an embodiment of the present disclosure.

FIG. 11 is a diagram illustrating a UE device according to an embodiment of the present disclosure.

FIG. 12 is a diagram illustrating a BS device according to an embodiment of the present disclosure.

FIG. 13 is a diagram illustrating an IAB node according to an embodiment of the present disclosure.

### BEST MODE

According to an embodiment of the present disclosure, a method, performed by an integrated access and backhaul (IAB) node, of transmitting and receiving data in a wireless communication system may include: receiving resource allocation information from an IAB donor node, receiving first resource scheduling information from a first parent IAB node, receiving second resource scheduling information from a second parent IAB node, transmitting and receiving data to and from at least one of the first parent IAB node, the second parent IAB node, a child IAB node, or a user equipment (UE), based on the resource allocation information, the first resource scheduling information and the second resource scheduling information.

### MODE FOR INVENTION

Hereinafter, exemplary embodiments of the present disclosure will now be described more fully with reference to the accompanying drawings. Here, it should be noted that the same reference numerals denote the same components in the accompanying drawings. Also, detailed descriptions of well-known functions and configurations which may obscure the present disclosure are not provided.

In the following descriptions of embodiments, descriptions of techniques that are well known in the art and are not directly related to the present disclosure are omitted. By omitting unnecessary descriptions, the essence of the present disclosure may not be obscured and may be explicitly conveyed.

For the same reason, some components in the drawings are exaggerated, omitted, or schematically illustrated. Also, size of each component does not exactly correspond to an actual size of each component. In each drawing, components that are the same or are in correspondence are rendered the same reference numeral.

Advantages and features of the present disclosure and methods of accomplishing the same may be understood more readily by reference to the following detailed descriptions of embodiments and accompanying drawings of the present disclosure. The present disclosure may, however, be embodied in many different forms and should not be construed as being limited to the embodiments set forth herein. Rather, these embodiments are provided so that this disclosure will be thorough and complete, and will fully convey the concept of the present disclosure to one of ordinary skill in the art. Therefore, the scope of the present disclosure is defined by the appended claims. Throughout the specification, like reference numerals refer to like components.

It will be understood that each block of flowchart illustrations, and combinations of blocks in the flowchart illustrations, may be implemented by computer program instructions. The computer program instructions may be provided to a processor of a general-purpose computer, special purpose computer, or other programmable data processing apparatus, such that the instructions, which are executed via the processor of the computer or other programmable data processing apparatus, generate means for performing functions specified in the flowchart block(s). The computer program instructions may also be stored in a computer-executable or computer-readable memory that may direct the computer or other programmable data processing apparatus to function in a particular manner, such that the instructions stored in the computer-executable or computer-readable memory may produce an article of manufacture including instruction means that perform the functions specified in the flowchart block(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

In addition, each block of the flowchart illustrations may represent a module, segment, or portion of code, which includes one or more executable instructions for performing specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The term “ . . . unit” as used in the present embodiment refers to a software or hardware component, such as field-programmable gate array (FPGA) or application-specific integrated circuit (ASIC), which performs certain tasks. However, the term “ . . . unit” does not mean to be limited to software or hardware. A “ . . . unit” may be configured to be in an addressable storage medium or configured to operate one or more processors. Thus, a “ . . . unit” may include, by way of example, components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in the components and “ . . . units” may be combined into fewer components and “ . . . units” or further separated into additional components and “ . . . units”. Further, the components and “ . . . units” may be implemented to operate one or more central processing units (CPUs) in a device or a secure multimedia card.

Hereinafter, terms identifying an access node, terms indicating network entities, terms indicating messages, terms indicating an interface between network entities, and terms indicating various pieces of identification information, as used in the following description, are exemplified for convenience of descriptions. Accordingly, the present disclosure is not limited to terms to be described below, and other terms indicating objects having equal technical meanings may be used.

Hereinafter, a base station is an entity that allocates resources to a terminal, and may be at least one of a next-generation node B (gNB), an evolved node B (eNB), a Node B, a base station (BS), a radio access unit, a BS controller, or a node on a network. A terminal may include a user equipment (UE), a mobile station (MS), a cellular phone, a smartphone, a computer, or a multimedia system capable of performing a communication function. Also, the term “terminals (UEs)” may refer to not only mobile phones, NB-IoT devices, and sensors but also other wireless communication devices. Obviously, the BS and the terminal are not limited to the examples.

For convenience of descriptions, in the present disclosure, terms and names defined in the 3^{rd} Generation Partnership Project Long Term Evolution (3GPP LTE) standard are used therein. However, the present disclosure is not limited to the terms and names, and may be equally applied to systems conforming to other standards.

Wireless communication systems providing voice-based services in early stages are being developed to broadband wireless communication systems providing high-speed and high-quality packet data services according to communication standards such as high speed packet access (HSPA), long term evolution (LTE) or evolved universal terrestrial radio access (E-UTRA), LTE-advanced (LTE-A), LTE-Pro of 3GPP, high rate packet data (HRPD), ultra mobile broadband (UMB) of 3GPP2, and 802.16e of the Institute of Electrical and Electronics Engineers (IEEE).

As a representative example of the broadband wireless communication systems, LTE systems employ orthogonal frequency division multiplexing (OFDM) for a downlink (DL) and employs single carrier-frequency division multiple access (SC-FDMA) for an uplink (UL). The UL refers to a radio link for transmitting data or a control signal from a terminal (e.g., a UE or an MS) to a base station (e.g., an eNB or a BS), and the DL refers to a radio link for transmitting data or a control signal from the base station to the terminal. The above-described multiple access schemes identify data or control information of each user in a manner that time-frequency resources for carrying the data or control information of each user are allocated and managed not to overlap each other, that is, to achieve orthogonality therebetween.

As post-LTE communication systems, i.e., 5G (or new radio (NR)) communication systems need to support services capable of freely reflecting and simultaneously satisfying various requirements of users, service providers, and the like. Services considered for the 5G systems include enhanced mobile broadband (eMBB), massive machine-type communication (mMTC), ultra-reliability low-latency communication (URLLC) services, or the like.

The eMBB aims to provide an improved data rate than a data rate supported by the legacy LTE, LTE-A, or LTE-Pro. For example, in a 5G communication system, the eMBB should be able to provide a peak data rate of 20 Gbps in a DL and a peak data rate of 10 Gbps in an UL at one BS. Also, the 5G communication system has to simultaneously provide the peak data rate and an increased user-perceived data rate of a UE. In order to satisfy such requirements, there is a need for an improvement in transmission/reception technology including an improved multiple-input multiple-output (MIMO) transmission technology. Also, a data rate required in the 5G communication system may be satisfied by using a frequency bandwidth wider than 20 MHz in the 3 GHz to 6 GHz or 6 GHz or more frequency band, instead of the LTE transmitting a signal by using maximum 20 MHz in the 2 GHz band.

Also, the mMTC is being considered to support application services such as IoT in the 5G communication system. In order to efficiently provide the IoT, the mMTC may require the support for a large number of terminals in a cell, improved coverage for a terminal, improved battery time, reduced costs of a terminal, and the like. Because the IoT is attached to various sensors and various devices to provide a communication function, the mMTC should be able to support a large number of terminals (e.g., 1,000,000 terminals/km²) in a cell. Also, because a terminal supporting the mMTC is likely to be located in a shadow region failing to be covered by the cell, such as the basement of a building, due to the characteristics of the service, the terminal may require wider coverage than other services provided by the 5G communication system. The terminal supporting the mMTC should be configured as a low-cost terminal and may require a very long battery life time of 10 to 15 years because it is difficult to frequently replace the battery of the terminal.

Lastly, the URLLC refers to cellular-based wireless communication services used for mission-critical purposes. For example, services for remote control of robots or machinery, industrial automation, unmanned aerial vehicles, remote health care, emergency alerts, and the like may be considered. Therefore, the URLLC should provide communications providing very low latency and very high reliability. For example, a service supporting the URLLC should satisfy air interface latency of less than 0.5 milliseconds, and simultaneously has a requirement for a packet error rate of 10-5 or less. Thus, for the service supporting the URLLC, the 5G system should provide a transmit time interval (TTI) smaller than other services and may simultaneously have a design requirement for allocating wide resources in a frequency band so as to ensure reliability of a communication link.

The three services of the 5G, i.e., the eMBB, the URLLC, and the mMTC may be multiplexed and transmitted in one system. Here, in order to satisfy different requirements of the services, the services may use different transceiving schemes and different transceiving parameters.

Although LTE, LTE-A, LTE Pro, or 5G (or NR, next-generation mobile communication) systems are mentioned as examples in the following description, embodiments of the present disclosure may also be applied to other communication systems having similar technical backgrounds or channel types. Furthermore, the embodiments of the present disclosure may also be applied to other communication systems through partial modification without greatly departing from the scope of the present disclosure based on determination by one of ordinary skill in the art. In 5G, when a BS transmits or receives data to or from a UE in bands equal to or greater than 6 GHz, millimeter wave (mmWave) bands in particular, coverage may be limited due to propagation path attenuation. The coverage limitation may be solved by arranging a plurality of relays (or relay nodes) densely in a propagation path between the BS and the UE, however, significant costs for installing optical cables for connecting backhauls between the relays may be a problem. Therefore, instead of installing the optical cables between the relays, a wideband radio frequency resource available for mmWave may be used to transmit or receive backhaul data between the relays so as to solve the costs problem of installing optical cables and more efficiently use the mmWave band.

A technology to use mmWave to transmit or receive backhaul data from the BS and transmit or receive access data finally to the UE via the plurality of relays as described above is referred to as integrated access and backhaul (IAB), and in this regard, a relay node that transmits or receives data to or from the BS by using wireless backhaul is referred to as an IAB node. Here, the BS includes a central unit (CU) and a distributed unit (DU), and the IAB node includes a DU and a mobile termination (MT). The CU may control DUs of all IAB nodes connected to the BS via multi-hops.

The IAB node may use different frequency bands or the same frequency band so as to receive backhaul data from the BS and transmit access data to the UE and to receive access data from the UE and transmit backhaul data to the BS. When using the same frequency band, the IAB node has a half-duplex constraint in an instant. Accordingly, as a method of reducing transmission and reception latency due to the half-duplex constraint of the IAB node, the IAB node, on reception, may perform frequency division multiplexing (FDM) and/or space division multiplexing (SDM) on backhaul data (downlink (DL) data from a DU of a parent IAB node to the MT of the IAB node and uplink (UL) data from an MT of a child IAB node to the DU of the IAB node) and access data from the UE (UL data from the UE to the IAB node).

Also, the IAB node, for transmission, may perform FDM and/or SDM on backhaul data (UL data from the MT of the IAB node to the DU of a parent IAB node and DL data from the DU of the IAB node to the MT of a child IAB node) and access data to the UE (DL data from the IAB node to the UE). Here, when the IAB node is configured for dual connectivity to a plurality of parent IAB nodes on a higher level of the IAB node, data transmission and reception between DUs of the parent IAB nodes and the MT of the IAB node and data transmission and reception between the DU of the IAB node and the MT of the child IAB on a lower level of the IAB node or the access UE are mixed, such that it may be difficult to satisfy the half-duplex constraint in an instant. The present disclosure may provide a method by which the IAB node is able to operate to conform to the half-duplex constraint in an environment where data transmission and reception are mixed environment. Here, embodiments of the present disclosure will now be described with reference to accompanying drawings.

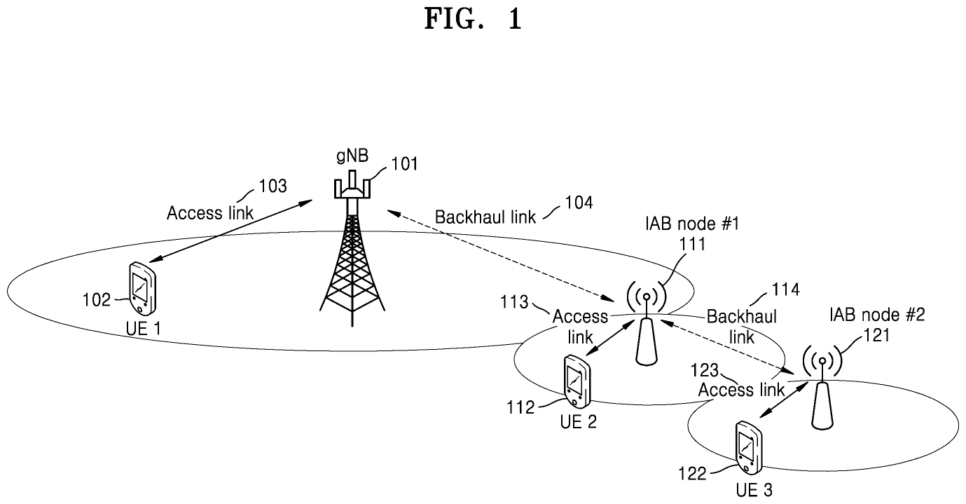

FIG. 1 illustrates a communication system where an IAB node is operated according to an embodiment of the present disclosure.

In FIG. 1, a gNB 101 is a common BS (e.g., eNB or gNB), and in the present disclosure, the gNB 101 is referred to as a gNB, eNB, BS, donor BS, or donor IAB. IAB node #1 111 and IAB node #2 121 are IAB nodes for performing backhaul link transmission and reception in the mmWave band. UE 1 102 transmits and receives access data to and from the gNB 101 via an access link 103. The IAB node #1 111 transmits and receives backhaul data to and from the gNB 101 via a backhaul link 104. UE 2 112 transmits and receives access data to and from the IAB node #1 111 via an access link 113. The IAB node #2 121 transmits and receives backhaul data to and from the IAB node #1 111 via a backhaul link 114. Therefore, the IAB node #1 111 is a higher IAB node of the IAB node #2 121 and is referred to as a parent IAB node, and the IAB node #2 121 is a lower IAB node of the IAB node #1 111 and is referred to as a child IAB node. UE 3 122 transmits and receives access data to and from the IAB node #2 121 via an access link 123.

Measurement of an IAB node or a donor gNB performed by the UE will now be described.

Coordination between the donor gNB and the IAB nodes may be required for the UE 2 112 or the UE 3 122 to perform measurement on the neighboring donor gNB or a neighboring donor IAB node which is not a serving IAB node. That is, the donor gNB may match measurement resources for IAB nodes having even hop order or match measurement resources for IAB nodes having odd hop order, thereby minimizing the waste of resources on which the UE performs measurement on the neighboring IAB node or IAB BS. The UE may receive a higher layer signal for a configuration to measure a synchronization signal block (SSB)/physical broadcast channel (PBCH) or a channel state information reference signal (CSI-RS) for measurement of the neighboring IAB node from the serving IAB node or the BS. When the UE is configured, via the SSB/PBCH, to perform measurement on a neighboring BS, the UE may be configured with at least two SSB/PBCH measurement timing configurations (SMTCs) for each frequency for measurement resources for IAB nodes having even hop order or measurement resources for IAB nodes having odd hop order. Upon receiving the configuration, the UE may perform measurement on the IAB node having even hop order in one SMTC and Mt perform measurement on the IAB node having odd hop order in the other SMTC.

Next, measurement of an IAB node performed by another IAB node or the donor gNB will now be described.

Coordination between the donor gNB and the IAB nodes may be required for an IAB node to perform measurement on another neighboring donor gNB or another neighboring IAB node. That is, the donor gNB may match measurement resources for IAB nodes having even hop order or match measurement resources for IAB nodes having odd hop order, thereby minimizing the waste of resources on which one IAB node performs measurement on a neighboring IAB node or IAB BS. One IAB node may receive a higher layer signal for a configuration to measure an SSB/PBCH or a CSI-RS for measurement of a neighboring IAB node, from a serving IAB node or BS. When an IAB node is configured, via the SSB/PBCH, to perform measurement on a neighboring BS, the IAB node may be configured with at least two SMTCs for each frequency for measurement resources for IAB nodes having even hop order or measurement resources for IAB nodes having odd hop order. Upon receiving the configuration, the IAB node may perform measurement on the IAB node having even hop order in one SMTC and perform measurement on the IAB node having odd hop order in another SMTC.

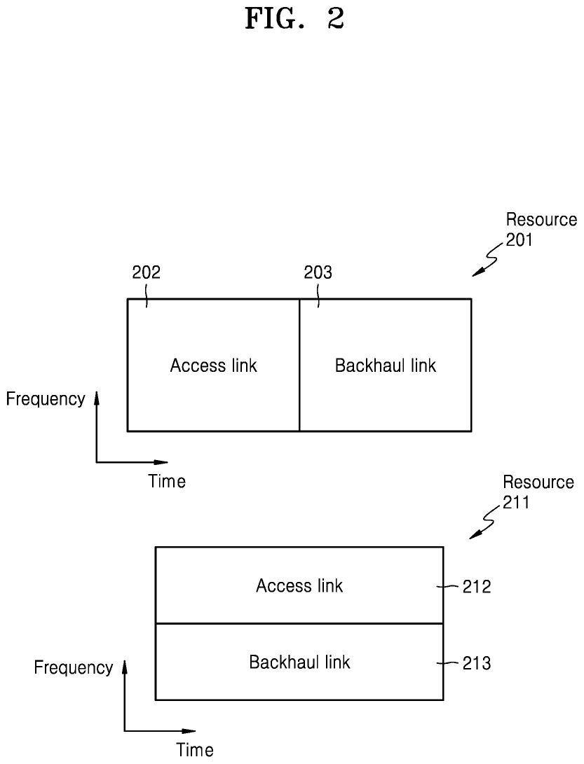

In an IAB technology as proposed in the present disclosure, multiplexing of a backhaul link between the BS and the IAB node or between IAB nodes and an access link between the BS and the UE or between the IAB node and the UE in radio resources will now be described in detail with reference to FIGS. 2, 3 and 4.

FIG. 2 is a diagram schematically illustrating multiplexing of an access link and a backhaul link at an IAB node according to an embodiment of the present disclosure. Time domain multiplexing of access link and backhaul link at an IAB node is shown in the upper part of FIG. 2. Frequency domain multiplexing of access link and backhaul link at an IAB node is shown in the lower part of FIG. 2.

In a radio resource 201 shown in the upper part of FIG. 2, a backhaul link 203 between the gNB and the IAB node or between IAB nodes and an access link 202 between the IAB node and the UE are time domain multiplexed (TDMed). Accordingly, in a time domain in which the gNB or the IAB node transmits and receives data to and from the UE, data transmission and reception between the gNB and IAB nodes is not performed, and in a time domain in which data transmission and reception is performed between the gNB and IAB nodes, the gNB or the IAB node does not transmit and receive data to and from the UE.

Next, in a radio resource 211 shown in the lower part of FIG. 2, a backhaul link 213 between the gNB and the IAB node or between IAB nodes and an access link 212 between the gNB and the UE or between the IAB node and the UE are FDMed. Accordingly, in a time domain in which the gNB or the IAB node transmits and receives data to and from the UE, it is possible to transmit and receive data between the gNB and IAB nodes but only unidirectional data transmission is possible due to the half-duplex constraint of the IAB nodes. That is, in a time domain in which an IAB node receives data from the UE, the IAB node may only receive backhaul data from another IAB node or a gNB. Also, in a time domain in which an IAB node transmits data to the UE, the IAB node may only transmit backhaul data to another IAB node or a gNB.

Although only TDM and FDM are described in connection with FIG. 2, spatial domain multiplexing (SMD) of the access link and the backhaul link in a spatial domain is also possible. Accordingly, the access link and the backhaul link may be transmitted and received at the same time via the SDM, but even with the SDM, data transmission in the same direction is only possible under the half-duplex constraints of IAB nodes as with the FDM in the lower part of FIG. 2. That is, in a time domain in which an IAB node receives data from the UE, the IAB node may only receive backhaul data from another IAB node or a gNB. Also, in a time domain in which an IAB node transmits data to the UE, the IAB node may only transmit backhaul data to another IAB node or a gNB.

Which multiplexing scheme of TDM, FDM and SDM is to be used may be configured by the IAB node transmitting a capability for the multiplexing scheme to the gNB or a higher IAB node when the IAB node performs initial access to the gNB or the higher IAB node and then receiving configuration information from the gNB or higher IAB nodes via system information or a radio resource control (RRC) signal, or receiving configuration information from the gNB or higher IAB nodes via a backhaul link after the initial access.

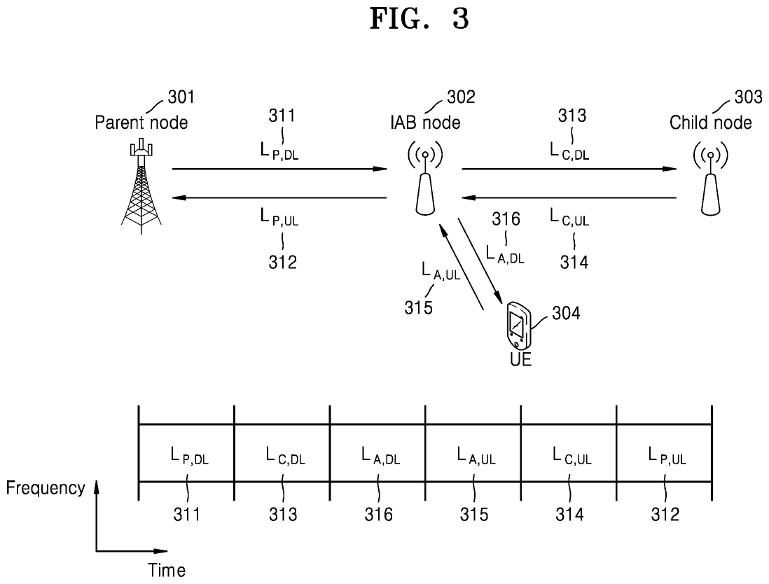

FIG. 3 is a diagram illustrating multiplexing of an access link and a backhaul link in the time domain in an IAB communication system according to an embodiment of the present disclosure.

In the upper part of FIG. 3, shown is a procedure in which an IAB node 302 communicates with a parent node 301, a child IAB node 303, and a UE 304. Explaining links between the respective nodes in more detail, the parent node 301 transmits a backhaul DL signal to the IAB node 302 in a backhaul DL link L_{P,DL}, (311) and the IAB node 302 transmits a backhaul UL signal to the parent node 301 in a backhaul UL link L_{P,DL} (312). The IAB node 302 transmits an access DL signal to the UE 304 in an access DL link L_{A,DL}, (316) and the UE 304 transmits an access UL signal to the IAB node 302 in an access UL link L_{A,UL} (315). The IAB node 302 transmits a backhaul DL signal to the child IAB node 303 in a backhaul DL link L_{C,DL} (313), and the IAB child node 303 transmits a backhaul UL signal to the IAB node 302 in a backhaul UL link L_{C,UL} (314). In the above notation, P refers to a backhaul link to a parent, A refers to an access link to the UE, and C refers to a backhaul link to a child.

These link relations are described with respect to the IAB node 302, and from the perspective of the IAB child node 303, the parent node is the IAB node 302 and the IAB child node 303 may have another IAB child node on its lower level. Also, from the perspective of the parent node 301, the child node is the IAB node 302, and the parent node 301 may have another IAB parent node on its higher level.

The aforementioned signal includes data and control information, a channel for transmitting the data and control information, a reference signal required to decode the data and the control information, or reference signals to figure out channel information.

In the lower part of FIG. 3, shown is a procedure for multiplexing the links all in the time domain. In the drawing, the backhaul DL link L_{P,DL} 311, the backhaul DL link L_{C,DL} 313, the access DL link L_{A,DL} 316, the access UL link L_{A,UL} 315, the backhaul UL link L_{C,UL} 314, and the backhaul UL link L_{P,DL} 312 are multiplexed in time order. The order of the links provided in the drawing is an example, but any order may be equally applied.

The links are multiplexed in time order in the time domain, and thus, it is apparent that the multiplexing scheme requires the longest time to transmit a signal from the parent node 301 to the child IAB node through the IAB node 302 and also even to the UE. Therefore, in order to reduce time latency in transmitting a signal from the parent node 301 to the UE finally, a method of multiplexing backhaul links or the backhaul link and the access link in the frequency domain or in the spatial domain at the same time and transmitting the result at the same time may be considered.

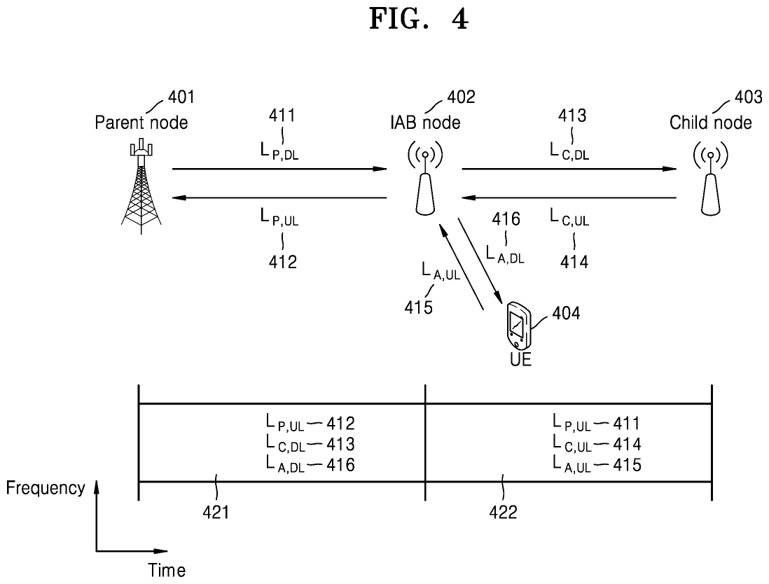

FIG. 4 is a diagram illustrating multiplexing of an access link and a backhaul link in frequency and spatial domains in an IAB communication system according to an embodiment of the present disclosure.

With reference to FIG. 4, a method of reducing time latency by multiplexing backhaul links or backhaul and access links in the frequency domain or in the spatial domain will now be described.

First, similar to FIG. 3, in the upper part of FIG. 4, shown is a procedure in which an IAB node 402 communicates with a parent node 401, a child IAB node 403, and a UE 404. Explaining links between the respective nodes in more detail, the parent node 401 transmits a backhaul DL signal to the IAB node 402 in a backhaul DL link L_{P,DL}, (411) and the IAB node 402 transmits a backhaul UL signal to the parent node 401 in a backhaul UL link L_{P,UL} (412). The IAB node 402 transmits an access DL signal to the UE 404 in an access DL link L_{A,DL}, (416) and the UE 404 transmits an access UL signal to the IAB node 402 in an access UL link L_{A,UL}(415). The IAB node 402 transmits a backhaul DL signal to the child IAB node 403 in a backhaul DL link L_{C,DL}, (413) and the IAB child node 403 transmits a backhaul UL signal to the IAB node 402 in a backhaul UL link L_{C,UL} (414). In the above notation, P refers to a backhaul link to a parent, A refers to an access link to a UE, and C refers to a backhaul link to a child.

These link relations are described with respect to the IAB node 402, and from the perspective of the IAB child node 403, the parent node is the IAB node 402 and the IAB child node 403 may have another IAB child node on its lower level. Also, from the perspective of the parent node 401, the child node is the IAB node 402, and the parent node 401 may have another IAB parent node on its higher level.

The aforementioned signal includes data and control information, a channel for transmitting the data and control information, a reference signal required to decode the data and the control information, or reference signals to figure out channel information.

Next, in the lower part of FIG. 4, shown is a scheme for multiplexing the aforementioned links in the frequency domain or the spatial domain.

As described above, the IAB node has a half-duplex constraint in an instant, so there are limitations on the signals that may be multiplexed in the frequency domain or the spatial domain. For example, when the half-duplex constraint of the IAB node 402 is considered, links available to be multiplexed in the time domain in which the IAB node may perform transmission are a backhaul UL link L_{P,DL} 412, a backhaul DL link L_{C,DL} 413, an access DL link L_{A,DL} 416, or the like. Accordingly, when the links are multiplexed in the frequency domain or the spatial domain, the IAB node 402 may transmit all the links in the same time domain as in 421. Also, links available to be multiplexed in the time domain in which the IAB node may perform reception are a backhaul DL link L_{P,DL} 411, a backhaul UL link L_{C,UL} 414, an access UL link L_{A,UL} 415, or the like. Accordingly, when the links are multiplexed in the frequency domain or the spatial domain, the IAB node 402 may receive all the links in the same time domain as in 422.

The multiplexing of the links provided in the drawing is one example, and it is possible that two of the three links multiplexed in the frequency or spatial domain may be multiplexed.

A structure of the IAB node will now be described.

For 5G, various forms of BS structure, which are optimal to service requirements, have been studied to support various services such as large-scale transmission, low-latency and high-reliable or a lot of machine-to-machine communication devices and reduce capital expenditures (CAPEX) for installing communication networks. In 4G LTE, in order to reduce CAPEX and effectively process interference control, a cloud radio access network (C-RAN) structure, in which a data processor and a wireless transceiver (or remote radio head (RRH)) in a BS are separated and the data processor is arranged in the center for processing and the wireless transceiver is arranged at a cell cite, has been commercialized. In the C-RAN structure, when the BS data processor transmits baseband digital IQ data to the wireless transceiver, an optical link of a common public radio interface (CPRI) standard is commonly used. When data is transmitted to the wireless transceiver, large data volume is required. For example, a transfer rate of 614.4 Mbps is required to transmit 10 MHz of Internet protocol (IP) data, and a transfer rate of 1.2 Gbps is required to transmit 20 MHz of IP data. Accordingly, the 5G RAN structure is designed to have various structures by dividing a BS (gNB) into a CU and a DU so as to reduce massive loads of optical links and applying functional split to the CU and DU. The 3GPP is working on standardization of many different functional split options for CU and DU. The functional split options are to split inter-protocol layer or intra-protocol layer into functions, and there may be a total of 8 options from option 1 to option 8, among which option 2 and option 7 are first considered in the current 5G BS structure. Option 2 has RRC and packet data convergence protocol (PDCP) layers located in the CU and radio link control (RLC), medium access control (MAC), physical (PHY) and radio frequency (RF) layers located in the DU. Option 7 has RRC, PDCP, RLC, MAC, and higher PHY layers located in the CU and has a lower PHY layer located in the DU. This functional split allows a structure having deployment flexibility to separate and migrate NR network protocols between the CU and the DU. This structure leads to flexible hardware implementation, providing a cost-effective solution, and the separation structure between the CU and the DU allows adjustment of load management and real-time performance optimization, enables network functions virtualization (NFV)/software defined network (SDN), and the configurable functional split may have an advantage of being applicable to various applications (variable latency in transmission).

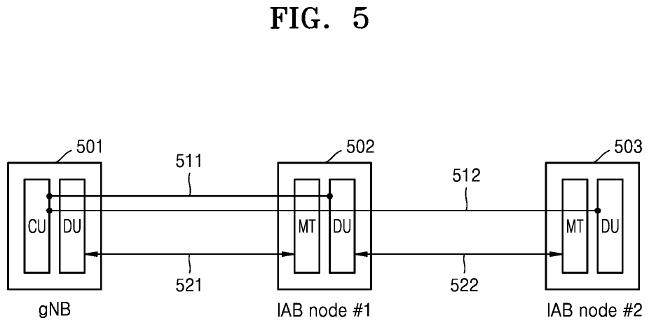

An architecture of an IAB node that considers the function split will now be described with reference to FIG. 5. FIG. 5 is a diagram schematically illustrating an architecture of an IAB node according to an embodiment of the present disclosure.

In FIG. 5, a gNB 501 includes a CU and a DU, and IAB nodes each include an MT for transmitting and receiving data to and from a parent node via a backhaul link and a DU for transmitting and receiving data to and from a child node via a backhaul link. In FIG. 5, IAB node #1 502 is wirelessly connected to the gNB 501 with one hop, and IAB node #2 503 is wirelessly connected to the gNB 501 via the IAB node #502 with two hops.

As shown in FIG. 5, the CU of the gNB 501 controls not only the DU of the gNB 501 but also controls DUs of all IAB nodes wirelessly connected to the gNB 501, i.e., the IAB node #1 502 and the IAB node #2 503 (511 and 512). The CU may allocate a radio resource to the DU so that the DU is able to transmit and receive data to and from an MT of an IAB node on a lower level of the DU. The allocating of the radio resource may be performed on the DU by using an F1 application protocol (F1AP) interface and transmitting system information, a higher layer signal or a physical signal. Here, the radio resource may be configured of a DL time resource, a UL time resource, a flexible time resource, and the like.

Configuration of the radio resource will now be described in detail based on the IAB node #2 503. The DL time resource is a resource for the DU of the IAB node #2 503 to transmit DL control/data and signals to the MT of an IAB node (not shown) on the lower level. The UL time resource is a resource for the DU of the IAB node #2 503 to receive UL control/data and signals from the MT of the IAB node on the lower level. The flexible time resource is a resource that may be used by the DU of the IAB node #2 503 as the DL time resource or the UL time resource, and how the flexible time resource is to be used may be indicated to the MT of the lower IAB node by a DL control signal of the DU of the IAB node #2 503. Upon receiving the DL control signal, the MT determines whether the flexible time resource is to be used for the DL time resource or the UL time resource. When failing to receive the DL control signal, the MT does not perform transmission or reception operation. That is, the MT does not monitor or decode the DL control channel on the resource or does not measure a signal on the resource. The MT does not perform transmission or reception operation on the resource. That is, the MT does not monitor or decode the DL control channel in the resource or does not measure a signal on the resource. Two different types (or three different types including the time resource that is always unavailable) for the DL time resource, the UL time resource, and the flexible time resource may be indicated from the CU to the DU.
The first type is a soft type in which the CU may use the F1AP (an interface between the CU and DU) to configure the DU of the IAB node #2 503 with a DL time resource, a UL time resource or a flexible time resource of the soft type. In this case, for the configured soft-type resources, the IAB node #1 502, a parent IAB node (or the DU of the parent IAB node) of the IAB node #2 503 may explicitly (e.g., by using a DCI format) or implicitly indicate to the IAB node #2 503, the child IAB node (or the DU of the child IAB node) whether the resource is available or not available. That is, when it is indicated that a particular resource is available, the DU of the IAB node #2 503 may use the resource for data transmission and reception to and from the MT of a lower IAB node. That is, the DU of the IAB node #2 503 may use the resource to perform transmission when the resource is the DL resource or to perform reception when the resource is the UL resource. When it is indicated that the particular resource is not available, the IAB node #2 503 may not use the resource for data transmission and reception to and from the MT of the lower IAB node. That is, the DU of the IA node #2 503 is unable to use the resource for transmission or reception.

A method of indicating the availability of the soft-type resource by using a DCI format will now be described in more detail. The DCI format in the embodiment may include an availability indicator to indicate availability of one or more successive UL, DL or flexible symbols.

The IAB node #2 503 may receive information about at least one of a location of the availability indicator indicating availability of the IAB node #2 in the DCI format, Table indicating availability of time resources corresponding to multiple slots, or a mapping relation of the availability indicator along with a cell ID of the DU of the IAB node #2 503 from the CU or the parent IAB node (e.g., the IAB node #1 502) by higher layer signals in advance so as to receive the DCI format. Values (or indicators) indicating availability of successive UL symbols, DL symbols, or flexible symbols in one slot and meanings of the values (or indicators) may be represented as in Table 1 below.

TABLE 1

| Value | Indication |
|---|---|
| 0 | No indication of availability for soft symbols |
| 1 | DL soft symbols are indicated available |
| | No indication of availability for UL and Flexible soft symbols |
| 2 | UL soft symbols are indicated available |
| | No indication of availability for DL and Flexible soft symbols |
| 3 | DL and UL soft symbols are indicated available |
| | No indication of availability for Flexible soft symbols |
| 4 | Flexible soft symbols are indicated available |
| | No indication of availability for DL and UL soft symbols |
| 5 | DL and Flexible soft symbols are indicated available |
| | No indication of availability for UL soft symbols |
| 6 | UL and Flexible soft symbols are indicated available |
| | No indication of availability for DL soft symbols |
| 7 | DL, UL, and Flexible soft symbols are indicated available |

When the availability indicator is indicated from the parent IAB node to the IAB node #2 503 in the DCI format and the IAB node #2 503 receives the indication, methods below may be considered as a method by which the DU of the IAB node #2 503 interprets relations between the DL, UL or flexible time resource and the availability configured for the IAB DU by the CU.

A first method is a method for an IAB DU to expect that the number of values indicating availability included in the availability indicator in the DCI format corresponds to the number of slots including a soft type of successive symbols configured by the CU. According to this method, the IAB DU may determine that the availability is applied only to the slots including the soft type.

A second method is a method for the IAB DU to expect that the number of values indicating availability included in the availability indicator in the DCI format corresponds to the number of all slots configured by the CU, i.e., the number of all slots having hard/soft/non-available (NA) types. In this embodiment, the IAB DU may determine that the availability is applied only to the slot having the soft type and that the availability is not applied to the slot having the hard or NA type without the soft type.

In the first and second methods, the IAB DU may expect that the meaning of a value that indicates the availability matches with a DL resource, a UL resource, or a flexible resource. For example, when only a DL soft resource or a DL hard resource exists in the slot, the IAB DU may expect that it is also possible that only a value of 1 is indicated in Table 1 in the above. Accordingly, among the values in Table, values including availability of the UL soft resource may not be expected to be indicated.

Alternatively, the IAB DU may determine that it is also possible that for at least the flexible resource configured by the CU, whether the DL resource or the UL resource is available is indicated in addition to the value indicating that the flexible resource is available. For example, for the flexible soft resource or the flexible hard resource, the DU of the IAB node may expect that it is possible to indicate a value of 1 or 2 instead of a value of 4 in Table 1. In this case, the DU of the IAB node #2 may determine that it is possible for the flexible resource to be used as UL or DL according to indication from the parent IAB instead of determination by the IAB node #2.

Alternatively, the IAB DU expects that a value of 0 may be indicated in above Table even for any hard/soft or NA resource configured by the CU. In this case, the IAB DU determines that the hard/soft resource that has been configured by the CU is not available, and the resource is regarded as not available for the DU of the IAB node #2 for data transmission or reception with the MT of a lower IAB node as in the case of the always-non-available resource type configured by the CU until indicated as available in the DCI format at a later time. When the resource is indicated by the DCI format as available again, the DU of the IAB node #2 may use the resource as configured by the CU or received in the DCI format.
The second type is a hard type, and the resources are always available between the DU and the MT. That is, regardless of transmission or reception operation of the MT of the IA node #2 503, the DU of the IAB node #2 503 may perform transmission when the resource is the DL time resource and may perform reception when the resource is the UL resource. When the resource is the flexible resource, the IAB DU may determine to perform transmission or reception (to correspond to the DCI format indicating to the MT of a lower IAB node whether the flexible resource is the DL resource or UL resource).
The third type is an always-not-used or always-non-available type, and the resources may not be used by the DU of the IAB node #2 for data transmission and reception to and from the MT.

The above types are received together when the DL time resource, the UL time resource, the flexible time resource, or a reserved time resource is received by the DU from the CU in a higher layer signal.

Next, the DU of the gNB 501 is a common BS, and the DU controls the MT of the IAB node #1 502 for scheduling of data transmission or reception (521). The DU of IAB #1 502 is a common BS, and the DU controls the MT of the IAB node #2 503 for scheduling of data transmission or reception (522).

The DU may indicate a radio resource for data transmission and reception to and from the MT of a lower IAB node, based on a radio resource allocated from the CU. Configuration of the radio resource may be transmitted to the MT via system information, a higher layer signal or a physical signal. Here, the radio resource may be configured of a DL time resource, a UL time resource, a flexible time resource, a reserved time resource, and the like. The DL time resource is a resource for the DU to transmit DL control/data and signals to the MT of the lower IAB node. The UL time resource is a resource for the DU to receive UL control/data and signals from the MT of the lower IAB node. The flexible time resource is a resource that may be used by the DU as the DL time resource or the UL time resource, and how the flexible time resource is to be used may be indicated to the MT of the lower IAB by a DL control signal of the DU. Upon receiving the DL control signal, the MT determines whether the flexible time resource is used for the DL time resource or the UL time resource. When failing to receive the DL control signal, the MT does not perform transmission or reception operation. That is, the MT does not monitor or decode the DL control channel on the resource or does not measure a signal on the resource.

The DL control signal is signaled to the MT as a combination of a higher layer signal and a physical signal, and the MT may determine a slot format in a particular slot by receiving the signaling. The slot format is basically formed to start with a DL symbol, have a flexible symbol located in the middle, and end with a UL symbol (i.e., a structure having an order of D-F-U). When only the slot format is used, the DU of the IAB node may be able to perform DL transmission at the start of the slot, but the MT of the IAB node configured by the parent IAB in the same slot format (i.e., the D-F-U structure) is unable to perform UL transmission at the same time (corresponding to slot format indexes 0 to 55 in Table 2 below). Accordingly, a slot format formed to start with the UL symbol, have the flexible symbol located in the middle and end with the DL symbol may be defined as in Table 2 below (corresponding to slot format indexes 56 to 96 in Table 2 below). The slot format defined in Table 2 below may be transmitted to the MT by using the DL control signal, and may be configured by the CU for the DU by using F1AP.

TABLE 2

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |
| 56 | U | U | U | U | U | U | U | U | U | U | U | U | U | F |
| 57 | U | U | U | U | U | U | U | U | U | U | U | U | F | F |
| 58 | U | U | U | U | U | U | U | U | U | U | U | F | F | F |
| 59 | U | U | U | U | U | U | U | U | U | U | F | F | F | F |
| 60 | U | U | U | U | U | U | U | U | U | F | F | F | F | F |
| 61 | U | U | U | U | U | U | U | U | F | F | F | F | F | F |
| 62 | U | U | U | U | U | U | U | F | F | F | F | F | F | F |
| 63 | U | U | U | U | U | U | F | F | F | F | F | F | F | F |
| 64 | U | U | U | U | U | F | F | F | F | F | F | F | F | F |
| 65 | U | U | U | U | F | F | F | F | F | F | F | F | F | F |
| 66 | U | U | U | F | F | F | F | F | F | F | F | F | F | F |
| 67 | U | U | F | F | F | F | F | F | F | F | F | F | F | F |
| 68 | U | F | F | F | F | F | F | F | F | F | F | F | F | F |
| 69 | U | F | F | F | F | F | F | F | F | F | F | F | F | D |
| 70 | U | U | F | F | F | F | F | F | F | F | F | F | F | D |
| 71 | U | U | U | F | F | F | F | F | F | F | F | F | F | D |
| 72 | U | F | F | F | F | F | F | F | F | F | F | F | D | D |
| 73 | U | U | F | F | F | F | F | F | F | F | F | F | D | D |
| 74 | U | U | U | F | F | F | F | F | F | F | F | F | D | D |
| 75 | U | F | F | F | F | F | F | F | F | F | F | D | D | D |
| 76 | U | U | F | F | F | F | F | F | F | F | F | D | D | D |
| 77 | U | U | U | F | F | F | F | F | F | F | F | D | D | D |
| 78 | U | U | U | U | U | U | U | U | U | U | U | U | F | D |
| 79 | U | U | U | U | U | U | U | U | U | U | U | F | F | D |
| 80 | U | U | U | U | U | U | U | U | U | U | F | F | F | D |
| 81 | U | U | U | U | U | U | U | U | U | U | U | F | D | D |
| 82 | U | U | U | U | U | U | U | U | U | U | F | F | D | D |
| 83 | U | U | U | U | U | U | U | U | U | F | F | F | D | D |
| 84 | U | F | D | D | D | D | D | D | D | D | D | D | D | D |
| 85 | U | U | F | D | D | D | D | D | D | D | D | D | D | D |
| 86 | U | U | U | F | D | D | D | D | D | D | D | D | D | D |
| 87 | U | F | F | D | D | D | D | D | D | D | D | D | D | D |
| 88 | U | U | F | F | D | D | D | D | D | D | D | D | D | D |
| 89 | U | U | U | F | F | D | D | D | D | D | D | D | D | D |
| 90 | U | F | F | F | D | D | D | D | D | D | D | D | D | D |
| 91 | U | U | F | F | F | D | D | D | D | D | D | D | D | D |
| 92 | U | U | U | F | F | F | D | D | D | D | D | D | D | D |
| 93 | U | U | U | U | U | U | U | U | U | F | F | F | F | D |
| 94 | U | U | U | U | U | U | F | F | F | F | F | F | D | D |
| 95 | U | U | U | U | U | U | F | F | D | D | D | D | D | D |
| 96 | U | U | U | U | U | U | U | D | D | D | D | D | D | D |

| | |
|---|---|
| 97~254 | Reserved |
| 255 | UE determines the slot format for the slot based on tdd-UL-DL- |
| | ConfigurationCommon, or tdd-UL-DL-ConfigurationDedicated and, if any, on |
| | detected DCI formats |
| | Or IAB MT determines the slot format for the slot based on tdd-UL-DL- |
| | ConfigurationCommon, or tdd-UL-DL-ConfigurationDedicated-IAB-MT and, if any, |
| | on detected DCI formats |

The reserved time resource is a resource on which the DU is unable to transmit and receive data to and from an MT on a lower level, so that the MT does not perform transmission or reception operation on the resource. That is, the MT does not monitor or decode the DL control channel on the resource or does not measure a signal on the resource.

Accordingly, an MT in an IAB node is controlled by a DU in an upper IAB node so as to receive scheduling for data transmission or reception, and the DU in the same IAB node is controlled by the CU of the gNB 501. That is, the MT and the DU in one IAB are controlled by different entities, and thus, may not be coordinated in real time.

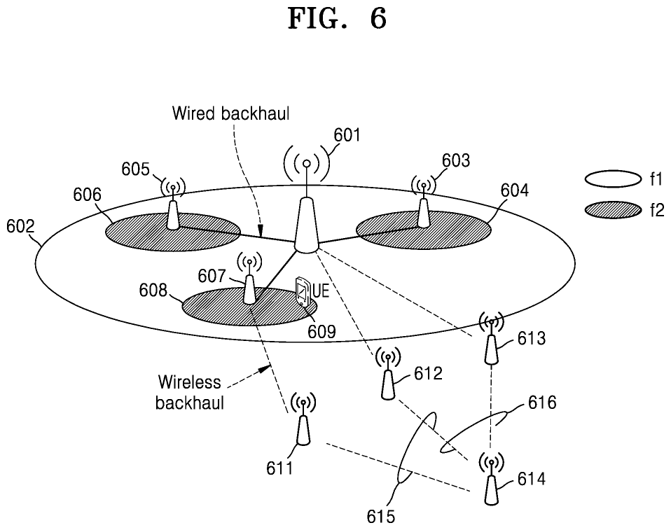

Next, FIG. 6 is a diagram illustrating a communication system according to an embodiment of the present disclosure. Although FIG. 6 illustrates an example of a system configured by combining a BS that uses a new radio access technology and an LTE/LTE-A BS, there may also be a system configured by combining BSs using the new radio access technology.

Referring to FIG. 6, small BSs 603, 605 and 607 having relatively small coverages 604, 606 and 608 may be deployed within coverage 602 of a macro BS 601. In general, the macro BS 601 is enabled to transmit signals with higher transmission power than the small BS 603, 605 or 607, such that the coverage 602 of the macro BS 601 is larger than the coverage 604, 606 or 608 of the small BS 603, 605 or 607. In the example of FIG. 6, the macro BS refers to an LTE/LTE-A system that operates in a relatively low-frequency band, and the small BS 603, 605, or 607 refers to a system to which a new radio access technology (NR or 5G) that operates in a relatively high-frequency band is applied.

The macro BS 601 and the small BSs 603, 605 and 607 may be connected to each other, and a certain degree of backhaul delay may exist depending on the connection state. Accordingly, it may not be desirable to exchange information between the macro BS 601 and the small BS 603, 605 or 607, the information being susceptible to the transmission delay.

Although the example of FIG. 6 illustrates carrier aggregation between the macro BS 601 and the small BS 603, 605 or 607, the present disclosure is not limited thereto and may be equally applied to carrier aggregation between BSs located in geologically different places. For example, in some embodiments, it may be equally applied to carrier aggregation between a macro BS and a macro BS located in different places or carrier aggregation between a small BS and a small BS located in different places. Also, there is no limitation on the number of carriers. Alternatively, the present disclosure may be applied to carrier aggregation in the macro BS 601 and carrier aggregation in the small BS 603, 605 or 607.

Referring to FIG. 6, the macro BS 601 may use frequency f1 for DL signal transmission, and the small BS 603, 605 or 607 may use frequency f2 for DL signal transmission. In this case, the macro BS 601 may transmit data or control information to a certain UE 609 on frequency f1, and the small BS 603, 605 or 607 may transmit data or control information to the UE 609 on frequency f2. With the aforementioned carrier aggregation, a BS to which the new radio access technology that supports high-frequency to ultra-high frequency bands is applied may provide an ultrahigh-speed data service and an ultra-low latency service, and along with the BS, a BS to which the LTE/LTE-A technology is applied in a relatively low-frequency band may support reliable UE mobility.

The configuration illustrated in FIG. 6 may be applied not only to DL carrier aggregation but may also be applied to UL carrier aggregation. For example, the UE 609 may transmit data or control information to the macro BS 601 on frequency f1′ for UL signal transmission. Also, the UE 609 may transmit data or control information to the small BS 603, 605 or 607 on frequency f2′ for UL signal transmission. The f1′ may correspond to the f1, and the 12′ may correspond to the f2. UL signal transmission of the UE to the macro BS and the small BS may be performed at different time points or at one time. In either case, due to the physical constraint of a power amplifier in the UE and the propagation constraint on the UE output power, a total of UL transmit power of the UE in a random time has to be maintained to be equal to or less than a certain threshold value.

An operation of the UE 609 that performs communication by accessing the macro BS 601 and the small BS 603, 605 or 607 in an environment as shown in FIG. 6 is referred to as dual connectivity (DC). When the UE performs dual connectivity, three configurations below may be possible.

According to the first configuration, the UE receives, via a higher layer signal (system or RRC signal), configuration information for data transmission and reception with respect to the macro BS 601 after the UE performs initial access to the macro BS 601 that operates as the LTE/LTE-A system. Afterward, the UE receives configuration information for data transmission and reception with respect to the micro BS 603, 605 or 607 that operates as an NR system via a higher layer signal (system or RRC signal) of the macro BS 601 and performs random access to the small BS 603, 605 or 607, and thus has a dual connectivity state in which the UE can transmit and receive data to and from the macro BS 601 and the small BS 603, 605 or 607. Here, the macro BS 601 operating as the LTE/LTE-A system is included in a master cell group (MCG), and the small BS 603, 605 or 607 operating as the NR system is included in a secondary cell group (SCG). When the UE is in the dual connectivity state, this may be expressed as the UE being configured with the MCG using E-UTRA radio access (or LTE/LTE-A) and the SCG using NR radio access. Alternatively, the UE may be expressed as being configured with E-UTRA NR dual connectivity (EN-DC).

According to the second configuration, after the UE performs initial access to the small BS 603, 605 or 607 operating as the NR system, the UE receives, via a higher layer signal (system or RRC signal), configuration information for data transmission and reception with respect to the small BS 603, 605, or 607. Afterward, the UE receives, via a higher layer signal (system or RRC signal) from the small BS 603, 605 or 607, configuration information for data transmission and reception with respect to the macro BS 601 operating as the LTE/LTE system and performs random access to the macro BS 601, and thus has the dual connectivity state in which the UE can transmit and receive data to and from the macro BS 601 and the small BS 603, 605 or 607. Here, the small BS 603, 605 or 607 that operates as the NR system is included in the MCG, and the macro BS 601 that operates as the LTE system is included in the SCG. When the UE is in the dual connectivity state, this may be expressed as the UE being configured with the MCG using NR radio access and the SCG using E-UTRA radio access (or LTE/LTE-A). Alternatively, the UE may be expressed as being configured with NR E-UTRA dual connectivity (NE-DC).

According to the third configuration, after the UE performs initial access to a first BS 601, 603, 605 or 607 operating as the NR system, the UE receives, via a higher layer signal (system or RRC signal), configuration information for data transmission and reception with respect to the first BS. Afterward, the UE receives, via a higher layer signal (system or RRC signal) from the first BS, configuration information for data transmission and reception with respect to a second BS 601, 603, 605 or 607 operating as the NR system and performs random access to the second BS, and thus, has a dual connectivity state in which the UE can transmit and receive data to and from the first BS and the second BS. Here, the first BS that operates as the NR system is included in the MCG, and the second BS that also operates as the NR system is included in the SCG. When the UE is in the dual connectivity state, this may be expressed as the UE being configured with the MCG using NR radio access and the SCG using NR radio access. Alternatively, the UE may be expressed as being configured with NR NR dual connectivity (NN-DC).

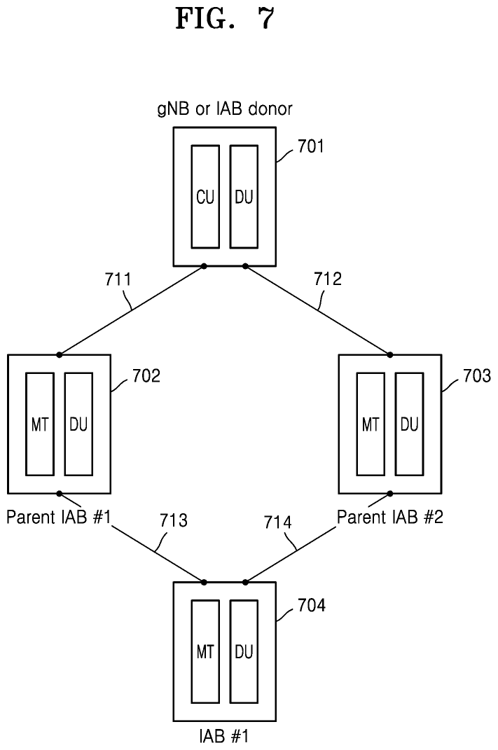

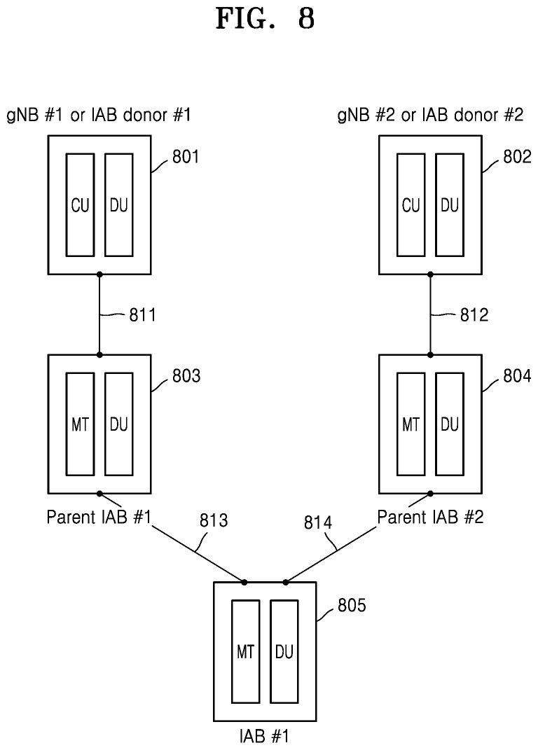

In the above descriptions, the dual connectivity configuration is described with respect to the certain UE 609, however, the dual connectivity configuration may also be applied to an IAB node 614. The dual connectivity configuration and access procedure of the UE 609 described above may also be applied to dual connectivity of the IAB node 614. Accordingly, the IAB node 614 may perform, by applying the dual connectivity procedure and method of the UE 609, dual connectivity to different parent IAB nodes 611 and 612 respectively connected to different donor BSs 601 and 607 via wireless backhaul (615) or to different parent IAB nodes 612 and 613 both connected to one donor BS 601 via wireless backhaul (616). With reference to FIGS. 7 and 8, the dual connectivity structure of an IAB node will now be described in detail.

First, with reference to FIG. 7, a structure in which an IAB node performs dual connectivity to different parent IAB nodes connected to one donor BS via wireless backhaul will now be described.

FIG. 7 is a diagram schematically illustrating a dual connectivity structure of an IAB node according to an embodiment of the present disclosure. The dual connectivity structure of the IAB node in FIG. 7 is a structure for which the function split described above in the present disclosure is considered.

In FIG. 7, a gNB 701 includes a CU and a DU, and IAB nodes each include an MT for transmitting and receiving data to and from a parent node via a backhaul link and a DU for transmitting and receiving data to and from a child node via a backhaul link. In FIG. 7, parent IAB node #1 702 is wirelessly connected to the gNB 701 with one hop (711), and parent IAB node #2 703 is wirelessly connected to the gNB 701 with one hop (712). IAB node #1 704 performs dual connectivity to the different parent IAB nodes #1 702 and #2 703, and is wirelessly connected to the gNB 701 via the different parent IAB nodes with two hops.

Although not illustrated in FIG. 7, the CU of the gNB 701 controls not only the DU of the gNB 701 but also controls DUs of all IAB nodes, i.e., the parent IAB node #1 702, the parent IAB node #2 703, and the IAB node #1 704, which are wirelessly connected to the gNB 701. The CU may allocate a radio resource to the DU so that the DU is enabled to transmit and receive data to and from an MT of an IAB node on a lower level of the DU. The allocating of the radio resource may be performed by transmitting, by using an F1AP interface, system information or a higher layer signal or a physical signal to the DU. Here, the IAB node of the DU that has received the radio resource uses the resource to transmit and receive DL control/data and signals or UL control/data and signals to and from the MT of a lower child IAB node according to the resource configuration configured with the DL time resource, the UL time resource, the flexible time resource, a resource type, availability, etc., and indication by the DU of the higher parent IAB node.

In FIG. 7, the IAB node #1 704 is in dual connectivity to the different parent IAB node #1 702 and parent IAB node #2 703, and the parent IAB node #1 702 and the parent IAB node #2 703 are connected to the one donor BS 701 via wireless backhaul. Accordingly, the MT in the IAB node #1 704 is controlled by each DU in the parent IAB node 702 or 703 on the higher level to receive scheduling for data transmission and reception, and the DU of the IAB node #1 704 has to serve as a BS for data transmission and reception with respect to the lower IAB node and the UE, such that the MT and the DU may not be coordinated in real time.

Next, with reference to FIG. 8, a structure in which an IAB node performs dual connectivity to different parent IAB nodes respectively connected to different donor BSs via wireless backhaul will now be described.

FIG. 8 is a diagram schematically illustrating a dual connectivity structure of an IAB node according to an embodiment of the present disclosure. The dual connectivity structure of the IAB node in FIG. 8 is a structure for which the function split described above in the present disclosure is considered.

In FIG. 8, gNB #1 801 includes a CU and a DU, and IAB nodes each include an MT for transmitting and receiving data to and from a parent node via a backhaul link and a DU for transmitting and receiving data to and from a child node via a backhaul link. In FIG. 8, parent IAB node #1 803 is wirelessly connected to the gNB #1 801 with one hop (811), and parent IAB node #2 804 is wirelessly connected to gNB #2 802 with one hop (812). IAB node #1 805 perform dual connectivity to the different parent IAB node #1 803 and parent IAB node #2 804, and is wirelessly connected to the gNB #1 801 and the gNB #2 802 via the different parent IAB nodes with two hops.

Although not illustrated in FIG. 8, the CU of the gNB #1 801 may control not only the DU of the gNB #1 801 but also control a DU of any lower IAB node wirelessly connected to the gNB #1 801, i.e., the parent IAB node #1 803, and the CU of the gNB #2 802 may control not only the DU of the gNB #2 804 but also control a DU of any lower IAB node wirelessly connected to the gNB #2 802, i.e., the parent IAB node #2 804. The DU of the IAB node #1 805 wirelessly connected to both the gNB #1 801 and the gNB #2 802 may be controlled by the CU of the gNB (e.g., the gNB #1) is included in the MCG.

The CU may allocate a radio resource to the DU so that the DU is enabled to transmit and receive data to and from an MT of an IAB node on a lower level of the DU. The allocating of the radio resource may be performed by transmitting, by using an F1AP interface, system information or a higher layer signal or a physical signal to the DU. Here, the IAB node of the DU that has received the radio resource uses the resource to transmit and receive DL control/data and signals or UL control/data and signals to and from the MT of a lower child IAB node according to the resource configuration configured with the DL time resource, the UL time resource, the flexible time resource, a resource type, availability, etc., and indication by the DU of the higher parent IAB node.

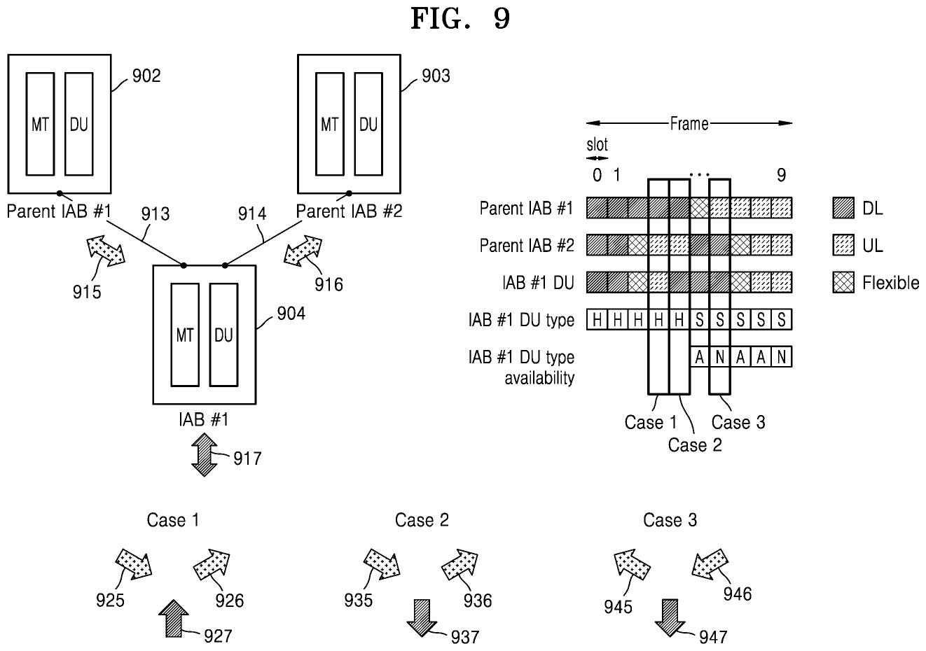

In FIG. 8, the IAB node #1 805 is in dual connectivity to the different parent IAB node #1 803 and parent IAB node #2 804, and the parent IAB node #1 803 and the parent IAB node #2 804 are respectively connected to different donor BSs 801 and 802 via wireless backhaul. Accordingly, as the MT in the IAB node #1 805 is controlled by DU in the parent IAB node 803 or 804 on the higher level so as to receive scheduling for data transmission and reception, and the DU of the IAB node #1 805 has to serve as a BS for data transmission and reception with respect to the lower IAB node and the UE, the MT and the DU may not be coordinated in real time as in the dual connectivity structure of FIG. 7. The details will be described with reference to FIG. 9.

FIG. 9 is a diagram schematically illustrating an environment that may occur in a dual connectivity structure of an IAB node according to an embodiment of the present disclosure.

FIG. 9 illustrates a situation where IAB node #1 904 is wirelessly connected to different parent IAB nodes by dual connectivity according to descriptions with reference to FIGS. 7 and 8 (e.g., where the IAB node #1 904 is wirelessly connected to parent IAB node #1 902 (913) and is wirelessly connected to parent IAB node #2 903 (916)), in which the parent IAB nodes indicate the resources described in FIGS. 5, 7 and 8 to the MT of the IAB node #1 904 and the CU of the gNB as in FIGS. 7 and 8 indicates resource allocation to the DU of the IAB node #1.

Here, as in 915 and 916 of FIG. 9, the MT of the IAB node #1 904 may perform DL reception or UL transmission according to configuration and indication from the parent IAB node #1 902 or parent IAB node #2 903, and as in 917 of FIG. 9, the DU of the IAB node #1 904 may perform UL reception or DL transmission according to configuration and indication to the MT of the lower IAB node.

The MT of the IAB node #1 904 determines the time resource as a DL time resource or a UL time resource or a flexible time resource, based on the configuration and indication from the DU of the parent IAB node #1902. Also, the MT of the IAB node #1 904 determines the time resource as a DL time resource or a UL time resource or a flexible time resource, based on the configuration and indication from the DU of the parent IAB node #2 903. Also, the DU of the IAB node #1 904 determines the time resource as a DL time resource or a UL time resource or a flexible time resource, according to configuration from the CU, and determines the resource to be hard (H), soft (S) or not available (NA) according to type.

Afterward, the MT of the IAB node #1 904 may receive DL control/data channel and reference signals when the time resource is determined as the DL time resource according to scheduling from the parent IAB node #1 902 or the parent IAB node #2 903, may transmit UL control/data channel and reference signals when the time resource is determined as the UL time resource, and may receive DL control/data channel and reference signals or transmit UL control/data channel and reference signals according to indication when the time resource is determined as the flexible time resource. On the other hand, although not illustrated in FIG. 9, the DU of the IAB node #1 904 may indicate to the MT of a lower IAB node to determine the time resource as the DL time resource, the UL time resource, or the flexible time resource according to the CU and transmit UL control/data channel and reference signals, and thus, may receive the UL control/data channel and reference signals or may transmit DL control/data channel and reference signals. Therefore, according to the indication and determination of the parent IAB nodes and configuration from the CU, the MT and DU of the IAB node #1 904 each have to determine and perform transmission and reception on the time resource, and in this case, a case in which the half-duplex constraint of the IAB node cannot be satisfied may occur. Cases 1, 2 and 3 of FIG. 9 will now be described in detail as an example.

In case 1, the MT of the IAB node #1 904 may determine the time resource as a DL time resource according to the indication from the DU of the parent IAB node #1 902 so as to receive DL control/data channel and reference signals, and simultaneously, the MT of the IAB node #1 904 may determine the time resource as a UL time resource according to the indication from the DU of the parent IAB node #2 903 so as to transmit UL control/data channel and reference signals, and simultaneously, the DU of the IAB node #1 904 may determine the time resource as a UL time resource to receive UL control/data channel and reference signals. Accordingly, in a case where the MT of the IAB node #1 904 has to perform reception and transmission with respect to the different parent IAB nodes and the DU has to perform reception, half-duplex constraint cannot be satisfied.

In case 2, the MT of the IAB node #1 904 may determine the time resource as a DL time resource according to the indication from the DU of the parent IAB node #1 902 so as to receive DL control/data channel and reference signals, and simultaneously, the MT of the IAB node #1 904 may determine the time resource as a UL time resource according to the indication from the DU of the parent IAB node #2 903 so as to transmit UL control/data channel and reference signals, and simultaneously, the DU of the IAB node #1 904 may determine the time resource as a DL time resource to transmit DL control/data channel and reference signals. Accordingly, in a case where the MT of the IAB node #1 904 has to perform reception and transmission with respect to the different parent IAB nodes and the DU has to perform transmission, half-duplex constraint cannot be satisfied.

In case 3, the MT of the IAB node #1 904 may determine the time resource as a UL time resource according to the indication from the DU of the parent IAB node #1 902 so as to transmit UL control/data channel and reference signals, and simultaneously, the MT of the IAB node #1 904 may determine the time resource as a DL time resource according to the indication from the DU of the parent IAB node #2 903 so as to receive DL control/data channel and reference signals, and simultaneously, the DU of the IAB node #1 904 may determine the time resource as a DL time resource to transmit DL control/data channel and reference signals. Accordingly, in a case where the MT of the IAB node #1 904 has to perform transmission and reception with respect to the different parent IAB nodes and the DU has to perform transmission (or reception), half-duplex constraint cannot be satisfied.

The present disclosure may provide embodiments of a method of transmitting and receiving data in a backhaul link while satisfying half-duplex constraint of an IAB node when transmission and reception of an MT conflicts with transmission and reception of a DU in the IAB node.

### Embodiment 1

In the embodiment 1, it is assumed a case where transmission and reception of the DU and transmission and reception of the MT of the IAB node #1 904 may conflict with each other when following the configuration from the CU or the indication or scheduling from the parent IAB node #1 902 or the parent IAB node #2 903 connected to the IAB node #1 904 by dual connectivity. In the embodiment 1, a procedure for the IAB node #1 904 may be determined according to whether the resource type of the DU of the IAB node #1 904 is hard, soft or non-available (NA).
When the resource type of the DU of the IAB node #1 904 is hard, the DU of the IAB node #1 904 may perform transmission and reception, without consideration of transmission and reception of the MT of the IAB node #1 904. That is, when the time resource of the DU of the IAB node #1 904 is for DL, the DU of the IAB node #1 904 may perform transmission, when the time resource of the DU of the IAB node #1 904 is for UL, the DU of the IAB node #1 904 may perform reception, and when the time resource of the DU of the IAB node #1 904 is flexible, the DU of the IAB node #1 904 may perform transmission or reception. In this case, schedulings only from the parent IAB nodes which correspond to the transmission or reception direction (i.e., which satisfy half-duplex constraint) of the DU of the IAB node #1 904 may be transmitted or received from the MT of the IAB node #1 904. For example, when the DU of the IAB node #1 904 performs transmission, the MT of the IAB node #1 904 may perform UL transmission according to indication from the parent IAB node scheduled for UL. Therefore, when the MT of the IAB node #1 904 is scheduled for DL, the indication from the parent IAB node cannot be followed, and the MT of the IAB node #1 904 cannot receive DL transmission.
When the resource type of the DU of the IAB node #1 904 is soft, the DU of the IAB node #1 904 may perform transmission or reception when at least one of conditions 1, 2 or 3 below is satisfied with respect to the half-duplex constraint. That is, when the at least one of the conditions 1, 2, or 3 is satisfied, the DU of the IAB node #1 904 may perform transmission when the time resource of the DU of the IAB node #1 904 is for DL, the DU of the IAB node #1 904 may perform reception when the time resource of the DU of the IAB node #1 904 is for UL, and the DU of the IAB node #1 904 may perform transmission or reception when the time resource of the DU of the IAB node #1 904 is flexible.

(Condition 1) The MT of the IAB node #1 904 does not perform transmission or reception at the same time as transmission or reception by the DU. That is, the condition 1 corresponds to a case where there is no scheduling for transmission or reception from the parent IAB nodes at the same time as transmission or reception by the DU.

(Condition 2) Because a transmission or reception direction of the DU of the IAB node #1 904 corresponds to the transmission or reception direction of the MT of the IAB node #1 904, the half-duplex constraint may be maintained, such that the transmission or reception direction of the DU of the IAB node #1 904 does not affect the transmission or reception of the MT of the IAB node #1 904. In this case, for example, for a transmission or reception direction of the MT of the IAB node #1 904, the transmission or reception direction scheduled or indicated from a parent IAB node included in an MCG may be first considered, and then the transmission or reception direction scheduled or indicated from a parent IAB node included in an SCG may be considered when there is no scheduling or indication of data transmission or reception from the parent IAB node included in the MCG.

(Condition 3) The MT of the IAB node #1 904 receives, from at least one parent IAB node, indication that a soft resource is available for the DU of the IAB node #1 904.
When the resource type of the DU of the IAB node #1 904 is NA, i.e., unavailable, for half-duplex constraint, the DU of the IAB node #1 904 does not perform transmission or reception. In this case, if schedulings conflict between parent IAB nodes, the MT of the IAB node #1 904 may prioritize scheduling from a parent IAB node that is included in the MCG. That is, the MT of the IAB node #1 904 may perform transmission or reception according to the scheduling from the parent IAB node included in the MCG, and may ignore the scheduling from the SCG when the scheduling from a parent IAB node included in the SCG cannot satisfy the half-duplex constraint.
When the DU of the IAB node #1 904 transmits an SS/PBCH block, transmits a PDCCH for SIB1 transmission, transmits a periodic CSI-RS or receives a PRACH or an SR on the time resource (i.e., a time resource on which transmission and reception of the DU and transmission and reception of the MT of the IAB node #1 904 may conflict with each other), the IAB node #1 904 may perform a procedure of the IAB node #1 904 for a case where the resource type of the DU of the IAB node #1 904 is hard, regardless of the resource type configured for the DU of the IAB node #1 904.

### Embodiment 2

In the embodiment 2, it is assumed a case where transmission and reception of the DU and transmission and reception of the MT of the IAB node #1 904 may conflict with each other when following the configuration from the CU or the indication or scheduling from the parent IAB node #1 902 or the parent IAB node #2 903 connected to the IAB node #1 904 by dual connectivity. In the embodiment 2, based on a direction of a resource of the DU of the IAB node #1 904, a procedure for the IAB node #1 904 may be determined according to whether the DU resource is for UL, DL or flexible. For example, when the direction of the resource of the DU of the IAB node #1 904 is for DL, the MT of the IAB node #1 904 may perform indication only from a parent IAB node scheduled by UL transmission to satisfy the half-duplex constraint. Therefore, the MT of the IAB node #1 904 may ignore the scheduling from a parent IAB node that cannot satisfy the half-duplex constraint.

### Embodiment 3

In the embodiment 3, it is assumed a case where transmission and reception of the DU and transmission and reception of the MT of the IAB node #1 904 may conflict with each other when following the configuration from the CU or the indication or scheduling from the parent IAB node #1 902 or the parent IAB node #2 903 connected to the IAB node #1 904 by dual connectivity. In the embodiment 3, based on a direction of resource or scheduling from a parent IAB node belonging to an MCG that performs scheduling for the MT of the IAB node #1 904, i.e., according to scheduling or resource configuration and indication from the parent IAB node belonging to the MCG, a procedure for the IAB node #1 904 may be determined according to whether the MT resource is for UL, DL or flexible. For example, the MT of the IAB node #1 904 may perform DL reception to satisfy the half-duplex constraint when the direction of a resource indicated or configured by the parent IAB node included in the MCG that performs scheduling for the MT of the IAB node #1 904 is for DL, and may receive data from a parent IAB node that is included in the SCG only when the direction of a resource indicated or configured by the parent IAB node that is included in the SCG is for DL, in which case the DU of the IAB node #1 904 may perform only UL reception. For example, when the direction of a resource indicated or configured by the parent IAB node that is included in the MCG that performs scheduling for the MT of the IAB node #1 904 is for UL, the MT of the IAB node #1 904 may perform UL transmission to satisfy the half-duplex constraint, and may transmit data from the parent IAB node that is included in the SCG only when the direction of a resource indicated or configured by the parent IAB node that is included in the SCG is for UL, in which case the DU of the IAB node #1 904 may perform only DL transmission. That is, the MT of the IAB node #1 904 may ignore the scheduling from the parent IAB node that is included in the SCG that cannot satisfy the half-duplex constraint.

### Embodiment 4

In the embodiment 4, it is assumed a case where transmission and reception of the MT of the IAB node #1 904 may conflict with each other when following the configuration from the CU or the indication or scheduling from the parent IAB node #1 902 or the parent IAB node #2 903 connected to the IAB node #1 904 by dual connectivity. In this case, it is assumed a case where the DU of the IAB node #1 904 does not perform transmission or reception. When schedulings received from the parent IAB nodes conflict with each other, the MT of the IAB node #1 904 may prioritize scheduling from the parent IAB node that is included in the MCG. That is, the MT of the IAB node #1 904 may perform transmission or reception according to the scheduling from the parent IAB node included in the MCG, and may ignore the scheduling from the SCG when the scheduling from a parent IAB node included in the SCG cannot satisfy half-duplex constraint.

One or more of the embodiments may be combined and used, and may be applied to some or all of the present disclosure.

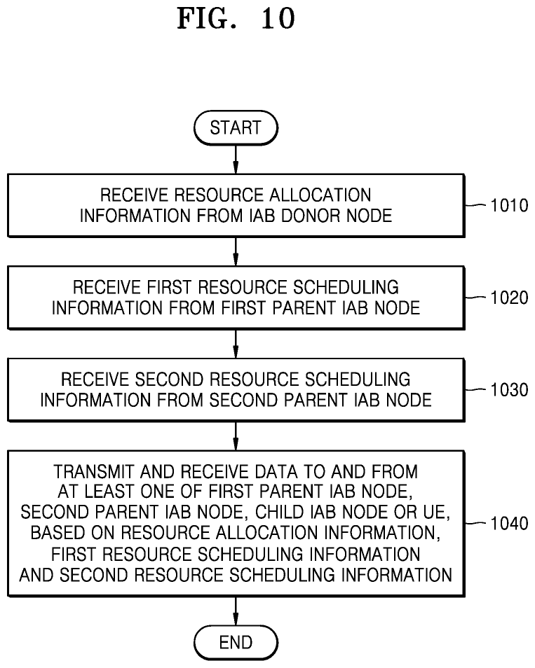

FIG. 10 is a flowchart for describing a method, performed by an IAB node, of transmitting and receiving data according to an embodiment of the present disclosure.

Referring to FIG. 10, in operation 1010, an IAB node according to an embodiment of the present disclosure may receive resource allocation information from an IAB donor node.

In operation 1020, the IAB node according to an embodiment of the present disclosure may receive first resource scheduling information from a first parent IAB node.

In operation 1030, the IAB node according to an embodiment of the present disclosure may receive second resource scheduling information from a second parent IAB node.

In operation 1040, the IAB node according to an embodiment of the present disclosure may transmit and receive data to and from at least one of the first parent IAB node, the second parent IAB node, a child IAB node, or a UE (e.g., a UE in a cell), based on the resource allocation information, the first resource scheduling information and the second resource scheduling information.

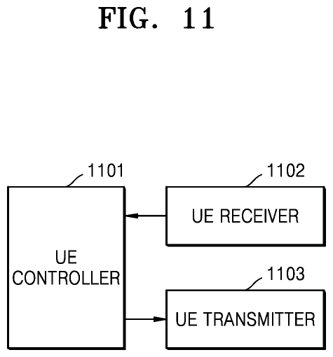

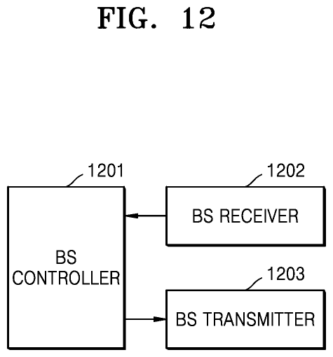

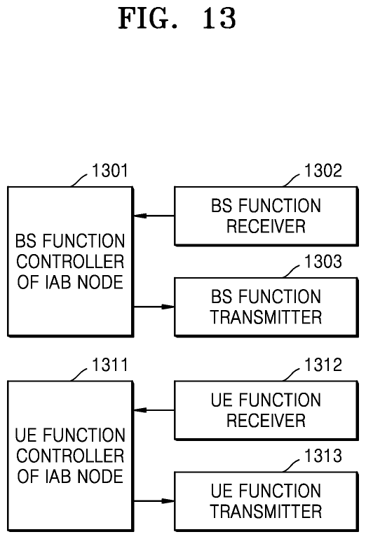

In order to perform the embodiments of the present disclosure, FIGS. 11 and 12 illustrate a transmitter, a receiver and a controller of a UE and a BS, respectively. Also, FIG. 13 illustrates a device of an IAB node. FIGS. 11 to 13 illustrate a transmission or reception method of a BS (a donor BS) that performs backhaul link transmission or reception with an IAB node on mmWave and a transmission or reception method of a UE that performs access link transmission or reception with the IAB node when backhaul link or access link is transmitted or received via the IAB node in a 5G communication system corresponding to embodiments of the present disclosure, and in order to perform the methods, the transmitter, the receiver and the processor of each of the BS, the UE and the IAB node may operate according to the embodiments.

FIG. 11 is a block diagram illustrating an internal structure of a UE according to an embodiment of the present disclosure. Referring to FIG. 11, the UE may include a UE controller 1101, a UE receiver 1102 and a UE transmitter 1103. Although not shown, the UE may further include a memory. However, components of the UE are not limited to the examples shown in FIG. 11. For example, the UE may include more components or fewer components than the components described above. In addition, the UE controller 1101, the UE receiver 1102, and the UE transmitter 1103 may be implemented in one chip.

The UE controller 1101 may control a series of procedures to make the UE operate according to the embodiments of the present disclosure. For example, the UE controller 1101 according to an embodiment of the present disclosure may differently control access link transmission or reception with respect to an IAB node. The UE controller 1101 may control the UE receiver 1102 and the UE transmitter 1103 to receive and transmit information. Also, the UE controller 1101 may include one or more processors.

The UE receiver 1102 and the UE transmitter 1103 may be collectively referred to as a transceiver in the embodiment of the present disclosure. The transceiver may transmit and receive signals to and from a BS. The signals may include control information and data. To this end, the transceiver may include an RF transmitter for up-converting and amplifying a frequency of a signal to be transmitted and an RF receiver for low-noise amplifying and down-converting a frequency of a received signal. Also, the transceiver may receive a signal on a wireless channel and may output the signal to the UE controller 1101, and may transmit, on a wireless channel, a signal output from the UE controller 1101.

The memory (not shown) may store a program and data required for operations of the UE. Also, the memory may store control information or data included in a signal obtained by the UE. The memory may include a storage medium such as a read only memory (ROM), a random access memory (RAM), a hard disk, a compact disc ROM (CD-ROM), and a digital versatile disc (DVD), or a combination of storage media. Also, the memory may not be separately present but may be included in the UE controller 1101. Also, the UE controller 1101 may control the components of the UE by executing the program stored in the memory.

FIG. 12 is a block diagram illustrating an internal structure of a BS according to an embodiment of the present disclosure. Referring to FIG. 12, the BS may include a BS controller 1201, a BS receiver 1202 and a BS transmitter 1203. Although not shown, the BS may further include a memory. However, components of the BS are not limited to the examples shown in FIG. 12. For example, the BS may include more components or fewer components than the components described above. In addition, the BS controller 1201, the BS receiver 1202 and the BS transmitter 1203 may be implemented in one chip.

The BS controller 1201 may control a series of procedures to make the BS operate according to the embodiments of the present disclosure. For example, backhaul link transmission or reception and access link transmission or reception with respect to an IAB node according to the embodiments of the present disclosure may be differently controlled. The BS controller 1201 may control the BS receiver 1202 and the BS transmitter 1203 to receive and transmit information. Also, the BS controller 1201 may include one or more processors.

The BS receiver 1202 and the BS transmitter 1203 may be collectively referred to as a transceiver in the embodiment of the present disclosure. The transceiver may transmit and receive signals to and from a UE. The signals may include control information and data. To this end, the transceiver may include an RF transmitter for up-converting and amplifying a frequency of a signal to be transmitted and an RF receiver for low-noise amplifying and down-converting a frequency of a received signal. Also, the transceiver may receive a signal on a wireless channel and may output the signal to the BS controller 1201, and may transmit, on a wireless channel, a signal output from the BS controller 1201.

The memory (not shown) may store a program and data required for operations of the BS. Also, the memory may store control information or data included in a signal obtained by the BS. The memory may include a storage medium such as a ROM, a RAM, a hard disk, a CD-ROM, and a DVD, or a combination of storage media. Also, the memory may not be separately present but may be included in the BS controller 1201. Also, the BS controller 1201 may control the components of the BS by executing the program stored in the memory.

FIG. 13 is a block diagram illustrating an internal structure of an IAB node according to an embodiment of the present disclosure. As shown in FIG. 13, the IAB node may include a BS function controller 1301, a BS function receiver 1302 and a BS function transmitter 1303 of the IAB node for performing transmission or reception with respect to a lower IAB node via a backhaul link. Also, the IAB node may include a UE function controller 1311, a UE function receiver 1312 and a UE function transmitter 1313, and the like of the IAB node to make initial access to a higher IAB node and a donor BS, perform transmission or reception of a higher layer signal before transmission or reception via a backhaul link, and perform transmission or reception with respect to the higher IAB node and the donor BS via a backhaul link. Although not shown, the IAB node may further include a memory. However, components of the IAB node are not limited to the examples shown in FIG. 13. For example, the IAB node may include more components or fewer components than the components described above. In addition, each component shown in FIG. 13 may be implemented in the form of one chip. Also, each of the BS function controller 1301 of the IAB node and the UE function controller 1311 of the IAB node may include one or more processors.

The BS function controller 1301 of the IAB node may control a series of procedures to make the IAB node operate according to the embodiments of the present disclosure, and for example, may perform the function of the DU of the IAB node as described above. For example, the BS function controller 1301 may differently control backhaul link transmission or reception with respect to a lower IAB node and access link transmission or reception with a UE. The BS function receiver 1302 and the BS function transmitter 1303 may be collectively referred to as a transceiver in the embodiments of the present disclosure. The transceiver may transmit and receive signals to and from the lower IAB node and the UE. The signals may include control information and data. To this end, the transceiver may include an RF transmitter for up-converting and amplifying a frequency of a signal to be transmitted and an RF receiver for low-noise amplifying and down-converting a frequency of a received signal. Also, the transceiver may receive a signal on a wireless channel and may output the signal to the BS function controller 1301, and may transmit, on a wireless channel, a signal output from the BS function controller 1301.

The UE function controller 1311 of the IAB node may control a series of procedures for the lower IAB node to operate as a UE for data transmission and reception with respect to a donor BS or a higher IAB node according to the aforementioned embodiment of the present disclosure, and for example, may perform the function of the MT of the IAB node as described above. For example, the UE function controller 1311 may differently control backhaul link transmission or reception with respect to the donor BS and a higher IAB node according to the embodiment of the present disclosure. The UE function receiver 1312 and the UE function transmitter 1313 may be collectively referred to as a transceiver in the embodiments of the present disclosure. The transceiver may transmit and receive a signal to and from the donor BS and the higher IAB node. The signals may include control information and data. To this end, the transceiver may include an RF transmitter for up-converting and amplifying a frequency of a signal to be transmitted and an RF receiver for low-noise amplifying and down-converting a frequency of a received signal. Also, the transceiver may receive a signal on a wireless channel and may output the signal to the UE function controller 1311, and may transmit, on a wireless channel, a signal output from the UE function controller 1311.

The memory (not shown) may store a program and data required for operations of the IAB node. Also, the memory may store control information or data included in a signal obtained by the IAB node. The memory may include a storage medium such as a ROM, a RAM, a hard disk, a CD-ROM, and a DVD, or a combination of storage media. Also, the memory may not be separately present but may be included in the BS function controller 1301 of the IAB node and/or the UE function controller 1311 of the IAB node. Also, the BS function controller 1301 of the IAB node and/or the UE function controller 1311 of the IAB node may control components of the IAB node by executing the program stored in the memory.

In the meantime, the BS function controller 1301 of the IAB node and the UE function controller 1311 of the IAB node included in the IAB node of FIG. 13 may be integrated to be implemented as an IAB node controller. In this case, the IAB node controller may control functions of both the DU and the MT in the IAB node.

The methods according to the embodiments of the present disclosure as described in claims or specification may be implemented as hardware, software, or a combination of hardware and software.

When implemented as software, a computer-readable storage medium which stores one or more programs (e.g., software modules) may be provided. The one or more programs stored in the computer-readable storage medium are configured for execution by one or more processors in an electronic device. The one or more programs include instructions directing the electronic device to execute the methods according to the embodiments of the present disclosure as described in the claims or the specification.

The programs (e.g., software modules or software) may be stored in non-volatile memory including RAM or flash memory, ROM, electrically erasable programmable read only memory (EEPROM), a magnetic disc storage device, a CD-ROM, a DVD, another optical storage device, or a magnetic cassette. Alternatively, the programs may be stored in memory including a combination of some or all of the above-mentioned storage media. Also, a plurality of such memories may be included.

In addition, the programs may be stored in an attachable storage device accessible through any or a combination of communication networks such as Internet, an intranet, a local area network (LAN), a wide LAN (WLAN), a storage area network (SAN), or the like. Such a storage device may access, via an external port, a device performing the embodiments of the present disclosure. Furthermore, a separate storage device on the communication network may access the electronic device performing the embodiments of the present disclosure.

In the afore-described embodiments of the present disclosure, components included in the present disclosure are expressed in a singular or plural form according to the embodiments. However, the singular or plural form is appropriately selected for convenience of descriptions and the present disclosure is not limited thereto. As such, a component expressed in a plural form may also be configured as a single component, and a component expressed in a singular form may also be configured as plural components. Meanwhile, the embodiments of the present disclosure described with reference to the present specification and the drawings are merely illustrative of specific examples to easily facilitate description and understanding of the present disclosure, and are not intended to limit the scope of the present disclosure. That is, it will be apparent to one of ordinary skill in the art that other modifications based on the present disclosure are feasible. Also, the embodiments may be combined to be implemented, when required. For example, portions of the methods provided by the present disclosure may be combined with each other to enable the BS and the UE to operate. Also, the embodiments of the present disclosure may be applied to other communication systems, and various modifications based on the technical concept of the embodiments may be feasible.

1. A method, performed by an integrated access and backhaul (IAB) node, of transmitting and receiving data in a wireless communication system, the method comprising:
receiving resource allocation information from at least one IAB donor node;
receiving resource scheduling information from a first parent IAB node and a second parent IAB node;
determining, based on the resource allocation information and the resource scheduling information, whether to transmit and receive data between the first and second parent IAB nodes and the IAB node and whether to transmit and receive data between a child IAB node or a user equipment (UE) and the IAB node; and
transmitting and receiving data to and from at least one of the first parent IAB node, the second parent IAB node, the child IAB node, or the UE, based on the determining to transmit and receive data.

2. The method of claim 1, wherein the determining, based on the resource allocation information and the resource scheduling information, of whether to transmit and receive data between the first and second parent IAB nodes and the IAB node and whether to transmit and receive data between the child IAB node or the UE and the IAB node comprises:
determining whether to transmit and receive data between the child IAB node or the UE and the IAB node, based on the resource allocation information and the resource scheduling information; and
determining whether to transmit and receive data between the first and second parent IAB nodes and the IAB node, based on a resource type to be used in transmission and reception of data between the child IAB node or the UE and the IAB node.

3. The method of claim 1, wherein the determining, based on the resource allocation information and the resource scheduling information, of whether to transmit and receive data between the first and second parent IAB nodes and the IAB node and whether to transmit and receive data between the child IAB node or the UE and the IAB node comprises:
determining whether to transmit and receive data between the child IAB node or the UE and the IAB node, based on the resource allocation information and the resource scheduling information; and
determining whether to transmit and receive data between the first and second parent IAB nodes and the IAB node, based on a resource direction to be used in transmission and reception of data between the child IAB node or the UE and the IAB node.

4. The method of claim 1,
wherein the first parent IAB node is an IAB node comprised in a master cell group (MCG), and
wherein the second parent IAB node is an IAB node comprised in a secondary cell group (SCG).

5. The method of claim 4, wherein the determining, based on the resource allocation information and the resource scheduling information, of whether to transmit and receive data between the first and second parent IAB nodes and the IAB node and whether to transmit and receive data between the child IAB node or the UE and the IAB node comprises:
determining whether to transmit and receive data between the first parent IAB node and the IAB node, based on the resource allocation information and the resource scheduling information; and
determining whether to transmit and receive data between the second parent IAB node and the IAB node and whether to transmit and receive data between the child IAB node or the UE and the IAB node, based on a resource direction to be used in transmission and reception of data between the first parent IAB node and the IAB node.

6. The method of claim 5, wherein, when the resource direction to be used in transmission and reception of data between the first parent IAB node and the IAB node is for a downlink, the determining of whether to transmit and receive data between the second parent IAB node and the IAB node and whether to transmit and receive data between the child IAB node or the UE and the IAB node, based on the resource direction to be used in transmission and reception of data between the first parent IAB node and the IAB node comprises:
when a resource direction, that is indicated or configured by the resource allocation information or the resource scheduling information and is to be used in transmission and reception of data between the second parent IAB node and the IAB node, is for a downlink, determining to receive data from the second parent IAB node; and
when a resource direction, that is indicated or configured by the resource allocation information or the resource scheduling information and is to be used in transmission and reception of data between the child IAB node or the UE and the IAB node, is for a downlink, determining to receive data from the child IAB node or the UE.

7. The method of claim 5, wherein, when the resource direction to be used in transmission and reception of data between the first parent IAB node and the IAB node is for a uplink, the determining of whether to transmit and receive data between the second parent IAB node and the IAB node and whether to transmit and receive data between the child IAB node or the UE and the IAB node, based on the resource direction to be used in transmission and reception of data between the first parent IAB node and the IAB node comprises:
when a resource direction, that is indicated or configured by the resource allocation information or the resource scheduling information and is to be used in transmission and reception of data between the second parent IAB node and the IAB node, is for a uplink, determining to transmit data to the second parent IAB node; and
when a resource direction, that is indicated or configured by the resource allocation information or the resource scheduling information and is to be used in transmission and reception of data between the child IAB node or the UE and the IAB node, is for a uplink, determining to transmit data to the child IAB node or the UE.

8. The method of claim 1, wherein the determining of whether to transmit and receive data comprises determining one of:
transmitting, by the IAB node, data;
receiving, by the IAB node, data; and
ignoring, by the IAB node, indication or configuration by the resource allocation information or the resource scheduling information that the IAB node is to transmit and receive data.

9. An integrated access and backhaul (IAB) node for transmitting and receiving data in a wireless communication system, the IAB node comprising:
a transceiver; and
at least one processor configured to:
receive resource allocation information from at least one IAB donor node,
receive resource scheduling information from a first parent IAB node and a second parent IAB node,
determine, based on the resource allocation information and the resource scheduling information, whether to transmit and receive data between the first and second parent IAB nodes and the IAB node and whether to transmit and receive data between a child IAB node or a user equipment (UE) and the IAB node, and
transmit and receive data to and from at least one of the first parent IAB node, the second parent IAB node, the child IAB node, or the UE, based on the determining to transmit and receive data.

10. The IAB node of claim 9, wherein the determining, based on the resource allocation information and the resource scheduling information, of whether to transmit and receive data between the first and second parent IAB nodes and the IAB node and whether to transmit and receive data between the child IAB node or the UE and the IAB node comprises:
determining whether to transmit and receive data between the child IAB node or the UE and the IAB node, based on the resource allocation information and the resource scheduling information; and
determining whether to transmit and receive data between the first and second parent IAB nodes and the IAB node, based on a resource type to be used in transmission and reception of data between the child IAB node or the UE and the IAB node.

11. The IAB node of claim 9, wherein the determining, based on the resource allocation information and the resource scheduling information, of whether to transmit and receive data between the first and second parent IAB nodes and the IAB node and whether to transmit and receive data between the child IAB node or the UE and the IAB node comprises:
determining whether to transmit and receive data between the child IAB node or the UE and the IAB node, based on the resource allocation information and the resource scheduling information; and
determining whether to transmit and receive data between the first and second parent IAB nodes and the IAB node, based on a resource direction to be used in transmission and reception of data between the child IAB node or the UE and the IAB node.

12. The IAB node of claim 9,
wherein the first parent IAB node is an IAB node comprised in a master cell group (MCG), and
wherein the second parent IAB node is an IAB node comprised in a secondary cell group (SCG).

13. The IAB node of claim 12, wherein the determining, based on the resource allocation information and the resource scheduling information, of whether to transmit and receive data between the first and second parent IAB nodes and the IAB node and whether to transmit and receive data between the child IAB node or the UE and the IAB node comprises:
determining whether to transmit and receive data between the first parent IAB node and the IAB node, based on the resource allocation information and the resource scheduling information; and
determining whether to transmit and receive data between the second parent IAB node and the IAB node and whether to transmit and receive data between the child IAB node or the UE and the IAB node, based on a resource direction to be used in transmission and reception of data between the first parent IAB node and the IAB node.

14. The IAB node of claim 13, wherein, when the resource direction to be used in transmission and reception of data between the first parent IAB node and the IAB node is for a downlink, the determining of whether to transmit and receive data between the second parent IAB node and the IAB node and whether to transmit and receive data between the child IAB node or the UE and the IAB node, based on the resource direction to be used in transmission and reception of data between the first parent IAB node and the IAB node comprises:
when a resource direction, that is indicated or configured by the resource allocation information or the resource scheduling information and is to be used in transmission and reception of data between the second parent IAB node and the IAB node, is for a downlink, determining to receive data from the second parent IAB node; and
when a resource direction, that is indicated or configured by the resource allocation information or the resource scheduling information and is to be used in transmission and reception of data between the child IAB node or the UE and the IAB node, is for a downlink, determining to receive data from the child IAB node or the UE.

15. The IAB node of claim 13, wherein, when the resource direction to be used in transmission and reception of data between the first parent IAB node and the IAB node is for a uplink, the determining of whether to transmit and receive data between the second parent IAB node and the IAB node and whether to transmit and receive data between the child IAB node or the UE and the IAB node, based on the resource direction to be used in transmission and reception of data between the first parent IAB node and the IAB node comprises:
when a resource direction, that is indicated or configured by the resource allocation information or the resource scheduling information and is to be used in transmission and reception of data between the second parent IAB node and the IAB node, is for a uplink, determining to transmit data to the second parent IAB node; and
when a resource direction, that is indicated or configured by the resource allocation information or the resource scheduling information and is to be used in transmission and reception of data between the child IAB node or the UE and the IAB node, is for a uplink, determining to transmit data to the child IAB node or the UE.
